(19) United States
(12) Patent Application Publication
(10) Pub. No.: US 2026/0208059 A1
(43) Pub. Date: Jul. 23, 2026

(54) COMPOUND COMPLIANT MECHANISMS, INTERLOCKING CONSTRUCTION BRICKS, AND MANUFACTURING METHODS THEREOF

(71) Applicant: Richard T Tieken, Belmont, MA (US)

(72) Inventor: Richard T Tieken, Belmont, MA (US)

(21) Appl. No.: 19/448,573

(22) Filed: Jan. 14, 2026

Related U.S. Application Data
(60) Provisional application No. 63/745,692, filed on Jan. 15, 2025.

(51) Int. Cl. A63H 33/08; B29C 64/118; B29C 64/30; B29C 64/40; B29L 31/52; B33Y 10/00; B33Y 80/00

(52) U.S. Cl. CPC A63H 33/086; B29C 64/118; B29C 64/30; B29C 64/40; B29L 2031/5209; B33Y 10/00; B33Y 80/00

(57) ABSTRACT

An interlocking construction brick and compound compliant mechanism system designed for additive manufacturing. The invention includes a “cup array” structure for the underside of bricks, comprising discrete binding cells separated by force normalization joints to manage material shrinkage and seam placement. The invention further utilizes compound friction-fit mechanisms comprising positioning aids, run-ins, and sacrificial or semi-sacrificial nubs to expand the tolerance range (“strike zone”) for user-satisfactory interlocking. Methods of manufacturing the same using FDM 3D printing, including the use of specific tuning blocks and embedded sidewall designs, are also disclosed.

### CROSS-REFERENCE TO RELATED APPLICATIONS

This application claims the benefit of priority to U.S. Provisional Application No. 63/745,692, filed Jan. 15, 2025, the entire contents of which are incorporated herein by reference.

### FIELD OF THE INVENTION

The present disclosure relates generally to mechanical fasteners and construction toys, and more specifically to compound friction-fit compliant mechanisms, interlocking construction brick structures comprising cup arrays, and methods for manufacturing the same using additive manufacturing.

### BACKGROUND OF THE INVENTION

Friction fit compliant mechanisms are fasteners that hold objects together via material deformation without external fasteners. Common examples include the stud-base pairing of interlocking construction bricks. These mechanisms typically rely on high-precision manufacturing to achieve a specific negative gap or overlap. However, high precision requirements limit the manufacturing techniques available, particularly excluding many consumer-grade FDM 3D printing technologies due to insufficient precision.

Standard interlocking bricks typically utilize a uniform friction fit mechanism. While effective with injection molding, errors in precision can lead to mechanisms that are either too tight or too loose, as the “strike zone” for a user-satisfactory fit is narrow. Snap-fit mechanisms offer higher tolerance but often lack backward compatibility and can be difficult to disassemble. Furthermore, FDM printing introduces variables such as seams, variable shrinkage, and material stiffness differences (e.g., PLA vs. PETG) that render standard brick designs non-user-satisfactory.

### SUMMARY OF THE INVENTION

The present disclosure provides a compound compliant mechanism that decouples the outline size of an object from its interface properties, thereby expanding the manufacturing tolerance strike zone. This is achieved through the use of positioning aids, run-ins, and nubs—including sacrificial and semi-sacrificial nubs—that allow for wider variance in manufacturing while maintaining user-satisfactory binding forces.

The disclosure further provides improvements to interlocking construction bricks, specifically the utilization of a “cup array” structure on the bottom interface. This structure manages material shrinkage, allows for seamless tuning of binding forces, and accommodates FDM manufacturing constraints.

Additionally, the disclosure provides methods for embedding designs, such as text or vectors, into the sidewalls of bricks using offset reliefs or multi-material printing, and methods for tuning manufacturing parameters to achieve consistent results across different materials.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A and 1B depict perspective section views of prior art interlocking bricks using a uniform friction fit compliant mechanism.

FIG. 2A-2C depict prior art compliant connectors including barb shapes and pen caps.

FIG. 3A-3C depict prior art bricks with uniform vein protrusions.

FIG. 4A-4B depict prior art snap-fit mechanisms.

FIG. 5A-5F are side view diagrams of various embodiments of a Class 1 compound compliant mechanism comprising nubs, run-ins, and positioning aids.

FIG. 6A-6C illustrate a Class 1 compound mechanism with a sacrificial or semi-sacrificial nub before and after wear-in.

FIG. 7A is an illustration comparing the “strike zone” of uniform interfaces versus non-sacrificial and semi-sacrificial nubs.

FIG. 8A-8C depict compound mechanisms arranged on male and female portions of an interface.

FIG. 9A-9B show cutaway perspective views of interlocking bricks incorporating the compound mechanisms of FIG. 8A.

FIG. 11A-11B depict Class 2 compound mechanisms comprising compliant springs.

FIG. 12A shows a brick incorporating the mechanism of FIG. 11B.

FIG. 13A-15B depict various embodiments of Class 2 compound mechanisms with vents, recovery slopes, and spring stabilizers.

FIG. 16A-17A depict Class 2 mechanisms forming a “peritube” (perimeter tube) spring.

FIG. 18A shows a cutaway of a brick comprising a square cup array and peritubes.

FIG. 21A-25B depict improvements allowing embedded and embossed designs, including text and vector graphics.

FIG. 26A-27A depict a square cup array structure for the bottom interface of a brick.

FIG. 28A-29A depict rectangular cup arrays, including checkerboard and alternating row orientations.

FIG. 30A-32B illustrate iso-angular cup patterns and bricks formed therefrom.

FIG. 33A-46A depict various embodiments of cup arrays combined with Class 2 compound mechanisms, wall voids, and spring arms.

FIG. 47A-51A depict modified cup arrays and diamond under-cylinders.

FIG. 52A shows a filament clip utilizing compound mechanisms.

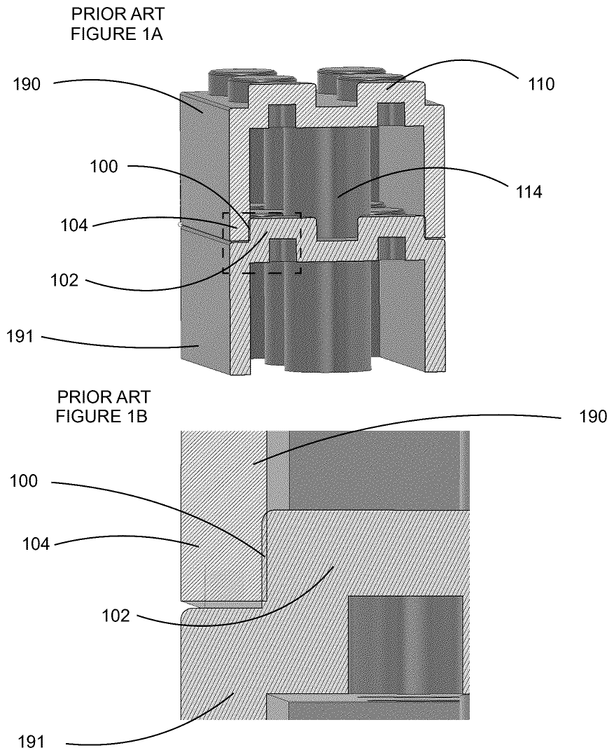

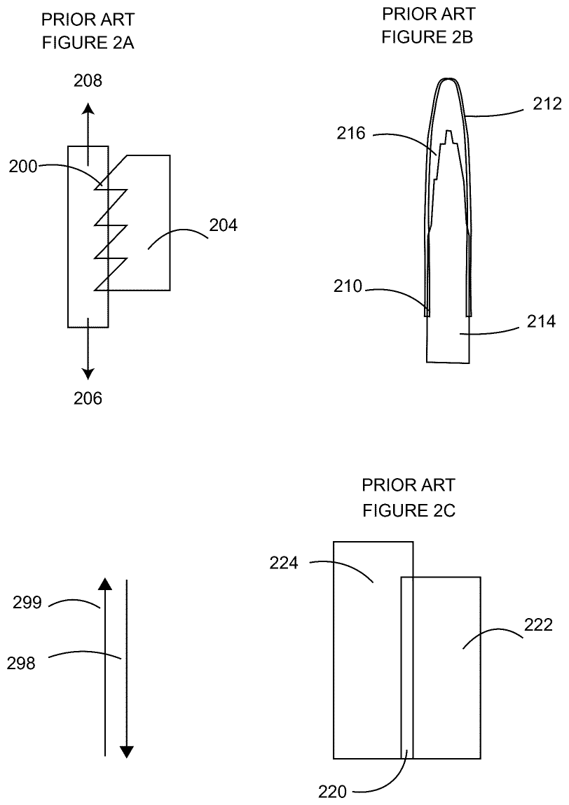

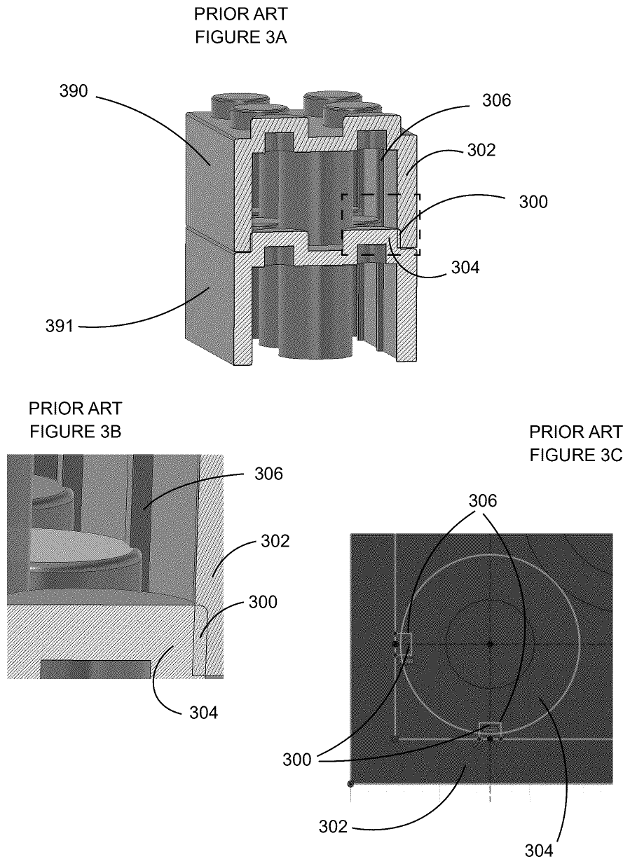

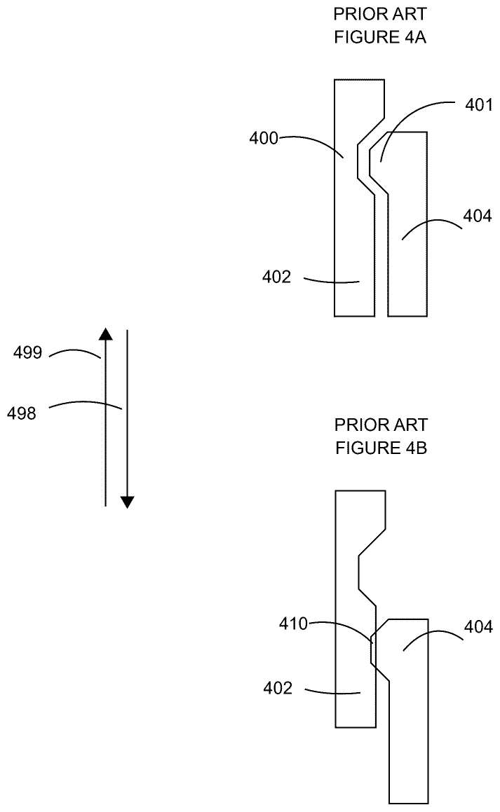

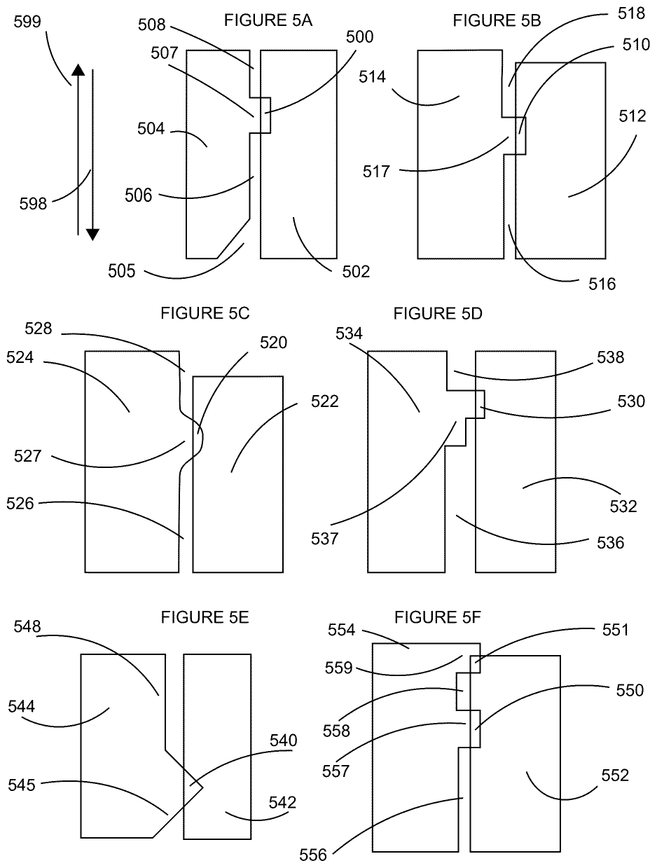

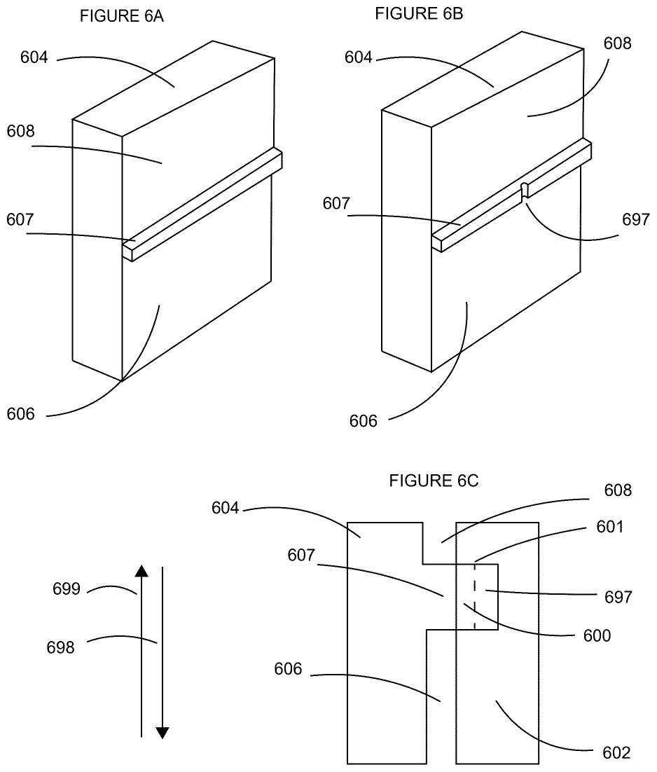

### DETAILED DESCRIPTION OF THE PREFERRED EMBODIMENTS

### I. Compound Compliant Mechanisms

The present invention provides a compound friction fit compliant mechanism designed to increase the “strike zone” or acceptable manufacturing tolerance range.

The primary parts in what is referred to herein as a “class one compound mechanism,” are nubs, run-ins, run-outs, and positioning aids. A class 1 compound mechanism has either: at least 1 nub+at least 1 run-in+zero or more run-outs+zero or more positioning aids-or-at least 1 nub+zero or more run-ins+at least 1 run-out+zero or more positioning aids.

A compound compliant mechanism can be placed on the male portion of the interface, the female portion of the interface, or both. As used herein, a positive protrusion in a compound compliant mechanism which creates an area within the interface area that is snug (has an overlap with its counterpart, or a greater overlap with its counterpart) is a nub. This is true regardless of the shape by which it rises from the baseline (sloped, circular/elliptical, flat, etc.) or the exact shape of the protrusion itself (square, rectangle, semi circle, triangle, etc) or the exact number of protrusions.

As used herein a section that is in the interface area but too-loose to bind with the counterpart (or still binds but significantly less than the nub) is a run-in or run-out. These are usefully combined with nub or nubs to adjust the overall tightness of the compound mechanism and to position the clamping force in the optimal location. As used herein, a decreasingly too loose/increasingly snug portion of the interface is a positioning aid. Positioning aids are often placed at the beginning of an interface. In some embodiments, particularly those with long run ups, two or more positioning aids may be desirable to progressively direct force before the counterpart reaches a nub or nubs. Positioning aids can be straight and angled, circular/elliptical, etc.

As used herein, nubs are divided into the following sub-categories: sacrificial nubs, non-sacrificial nubs, and semi-sacrificial nubs. As used herein, a sacrificial nub is achieved when the nub is made of a sheerable material, is of a thin enough profile (height, width, and depth), and protrudes enough that the excess protrusion that interfaces with the counterpart mechanism can be sheared off and/or smushed down thereby reducing the size of the protrusion back to within user-satisfactory parameters.

As used herein, a non-sacrificial nub is a nub that due to its materials, manufacturing, and shape is not expected to or not able to wear down or wear in when used within intended parameters.

As used herein, a semi-sacrificial nub is a nub sized such that it will be sacrificial and sheared away if at the upper end of a range but non-sacrificial and function without shearing if it is at the lower end of a range. Sacrificial, non-sacrificial, and semi-sacrificial nubs are all useful in increasing the strike zone, that is to say, the range of sizes that achieve user-satisfactory fits. This is useful in reducing manufacturing cost by reducing required manufacturing precision. It is also useful in allowing the same 3D object to be manufactured with a variety of materials with less or even no modifications between materials and machines.

Having sacrificial or semi-sacrificial nubs allows compound mechanisms that are too large to be worn-in and become user-satisfactory. Often, this wear-in can be rapid, taking one or a few cycles. An object with a semi-sacrificial nub will sometimes be designed so that nominal size is at the middle of the useful range/strike zone, the location of this point is calculated by the equation (lower size variance without shearing+upper size variance with shearing)/2. A semi-sacrificial nub so-designed will maximize the range of manufacturing variances across which a resulting part will be user-satisfactory.

Another useful embodiment of a semi sacrificial nub is when the nominal size of the nub is set to one third of the userful range/strike zone, the location of this point is calculated by the equation (lower size variance without shearing+upper size variance with shearing)/3. Sizing a nub as such increases the chance that the nub will not require shearing or wearing in, but also increases the chance that the nub could be too loose to be user-satisfactory due to manufacturing variances.

Nubs, as described here differ from the z-axis uniform protrusions as in those used by Lego as discussed above in many ways including at least that 1) nubs create a non uniform interface for the counterpart 2) nubs typically run in the x and y dimensions, Lego's protrusions has instead a uniform profile in those dimensions 3) nubs can be sacrificial or semi sacrificial, the Lego protrusion is non sacrificial.

As used herein, a friction fit compliant mechanism that does not have a nub is a uniform friction fit mechanism. Uniform friction fit mechanisms are well documented in prior art.

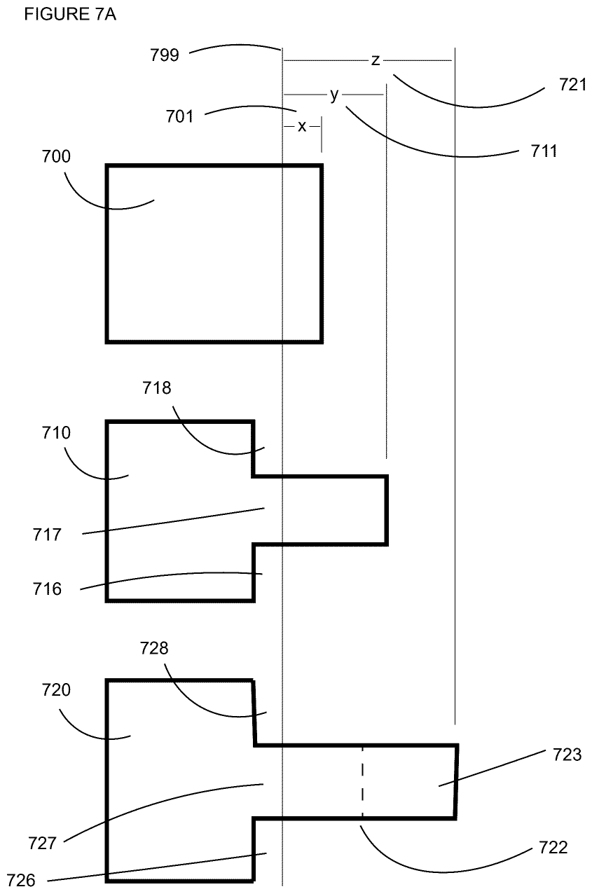

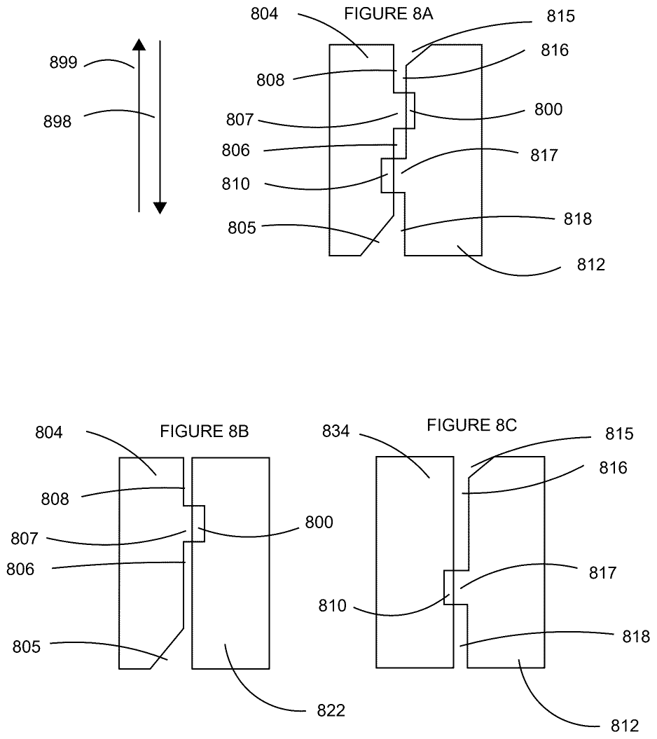

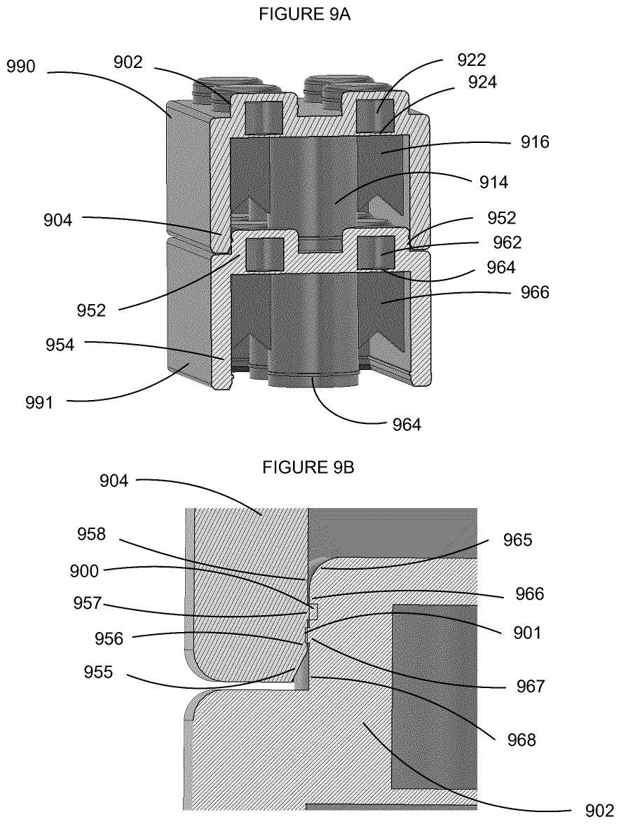

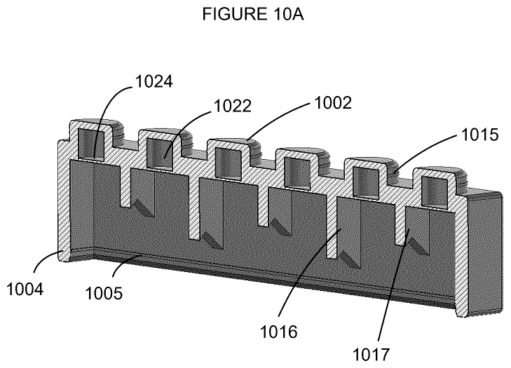

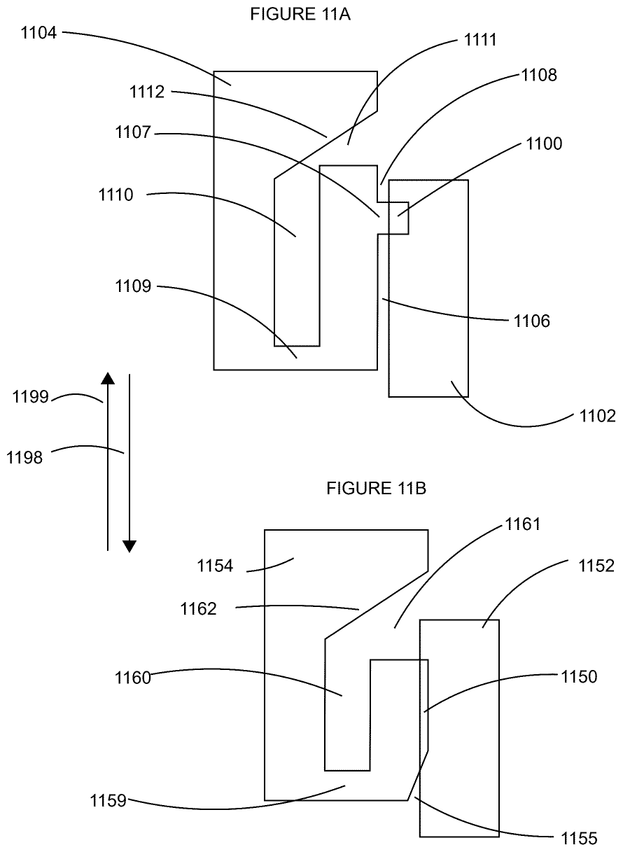

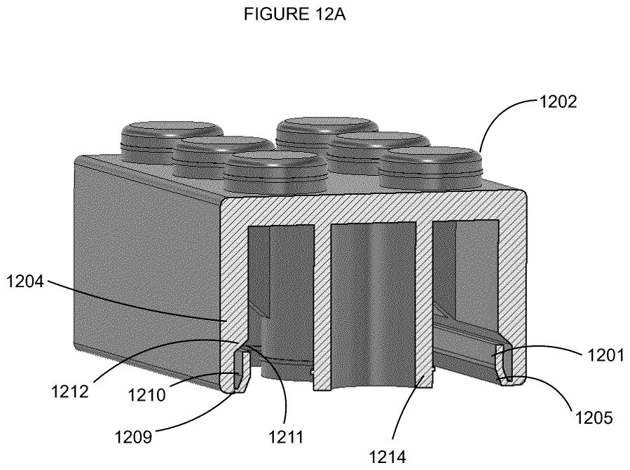

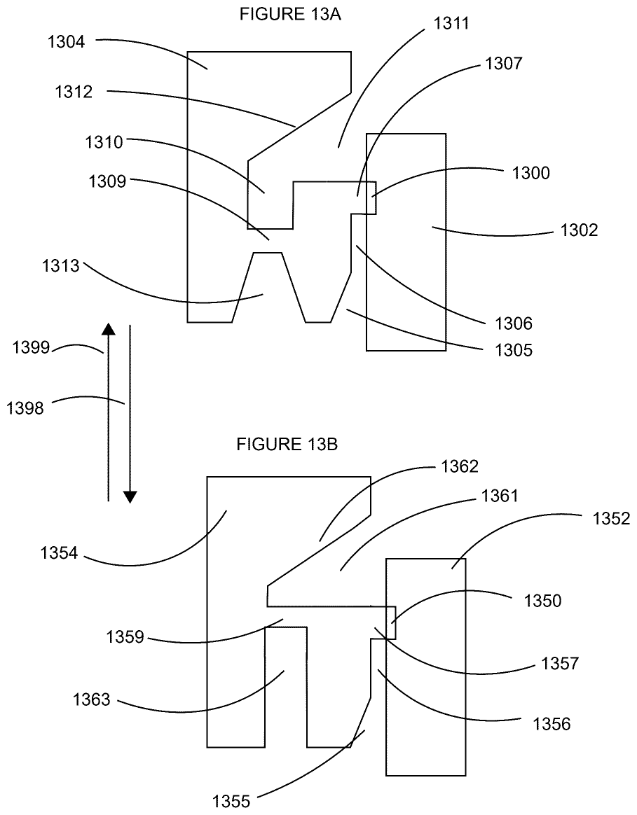

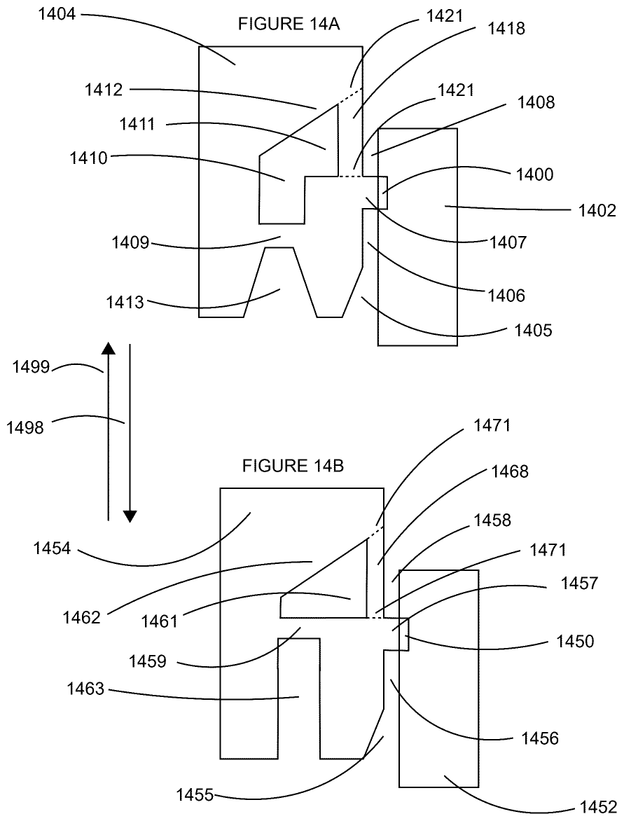

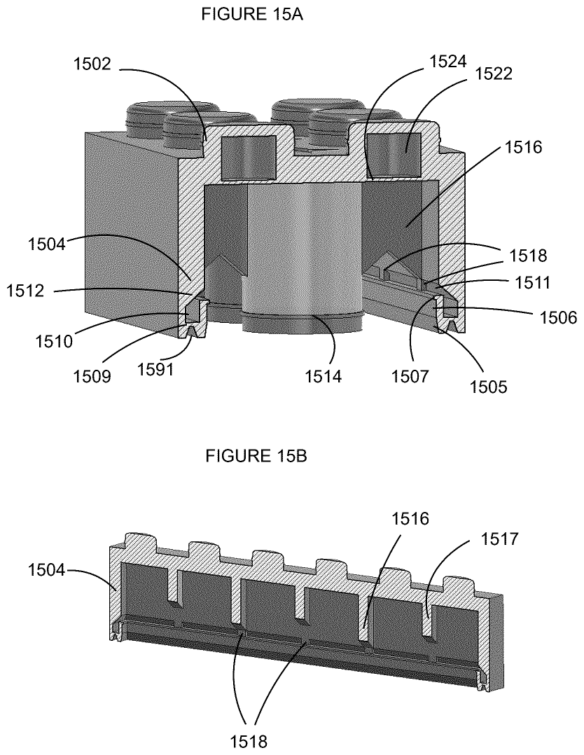

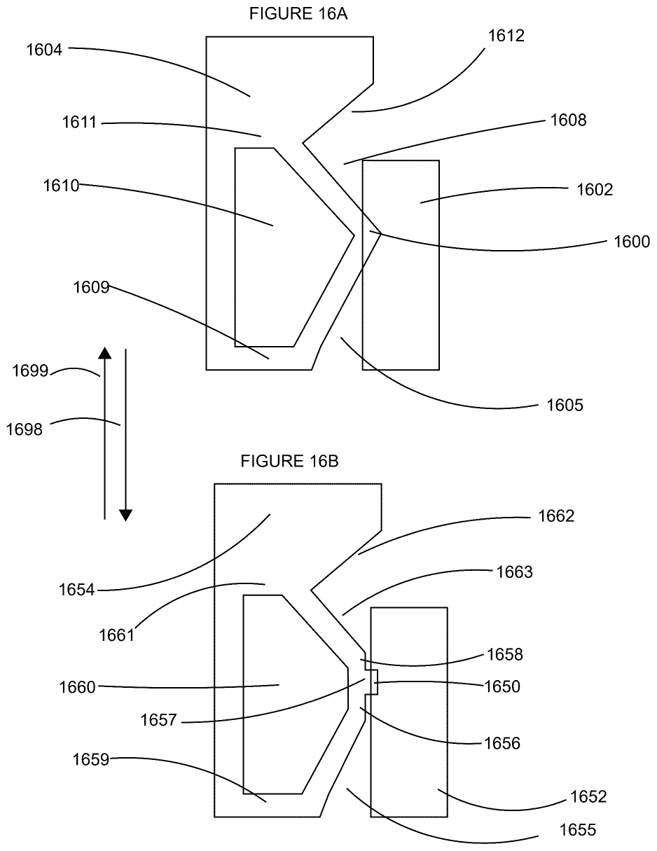

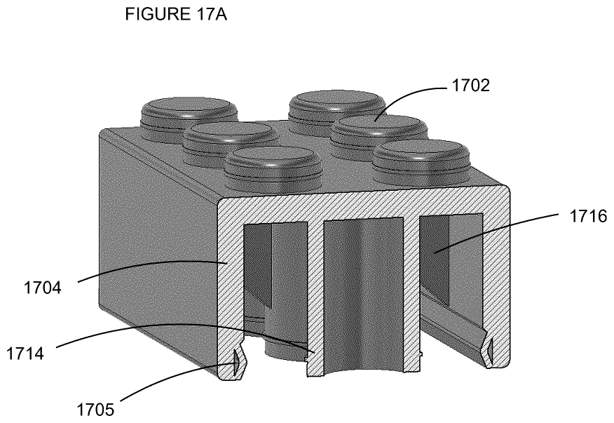

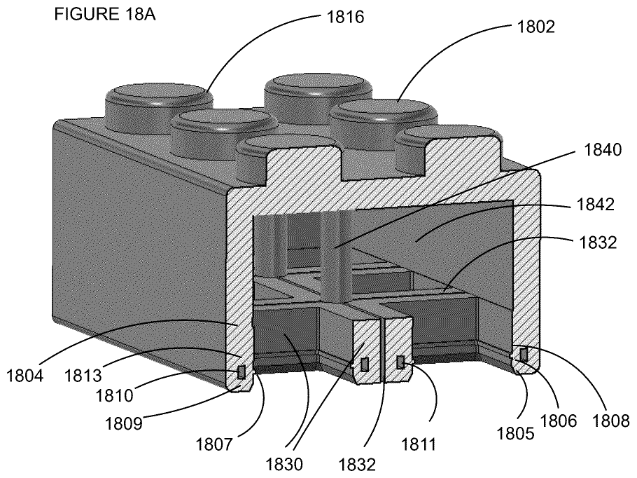

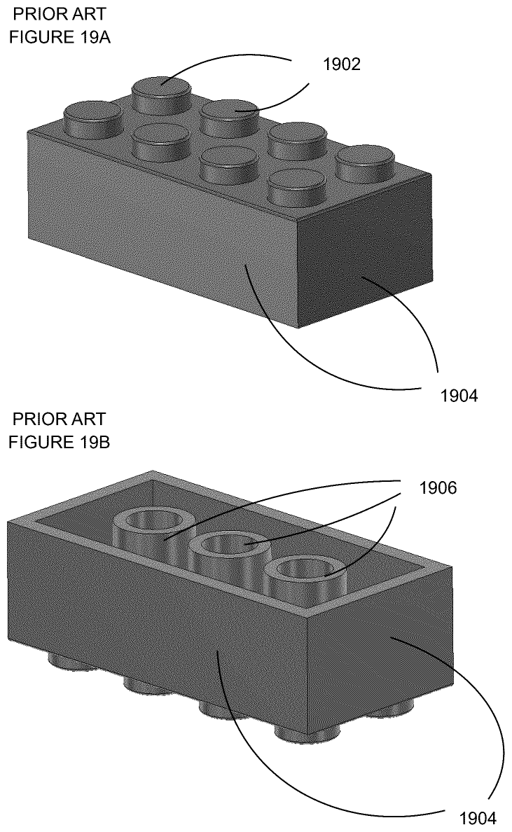

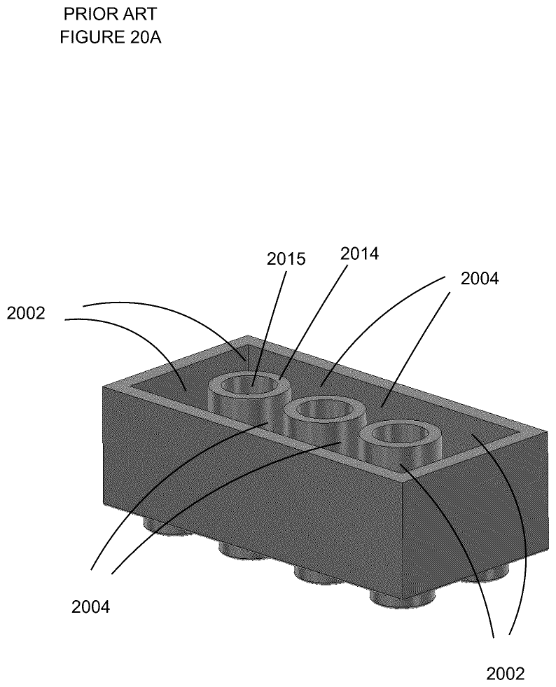

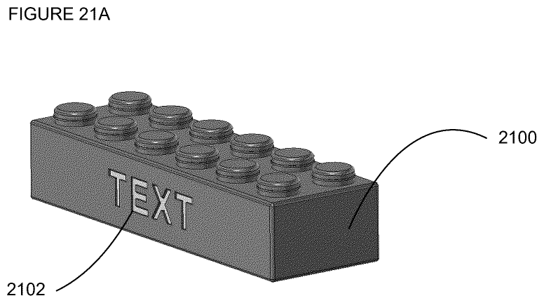

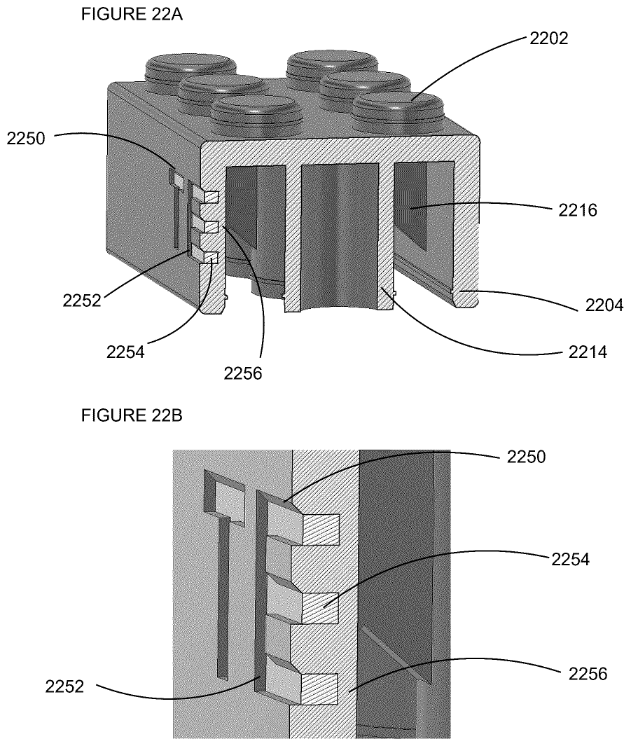

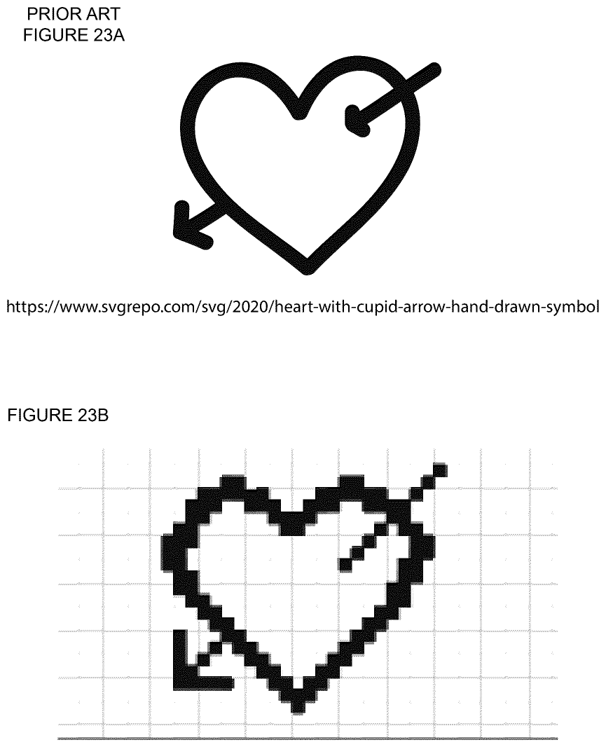

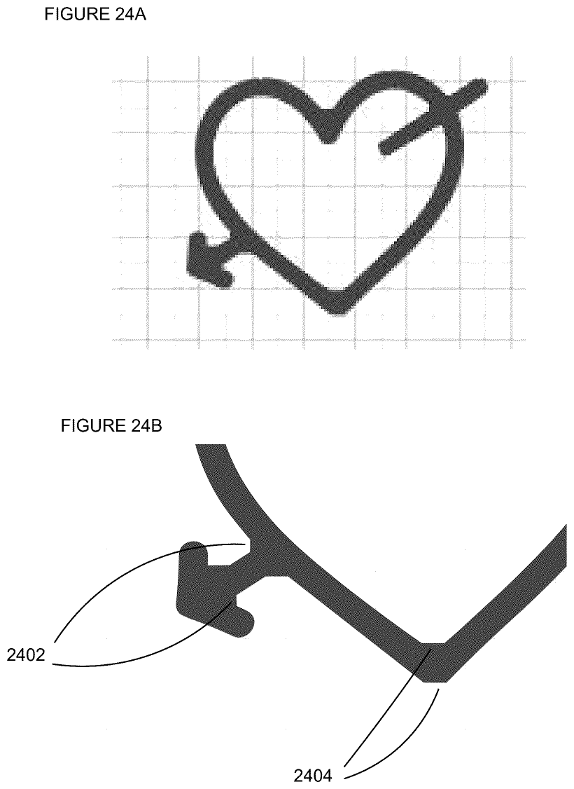

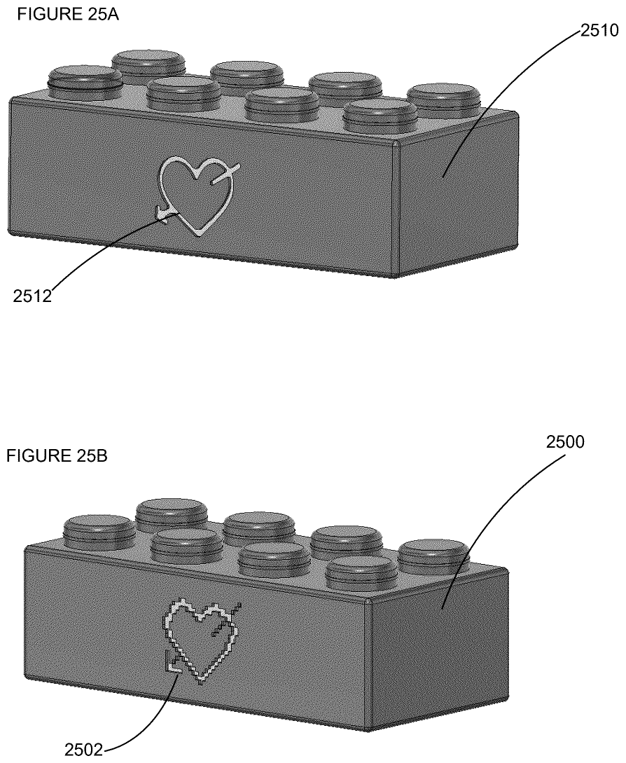

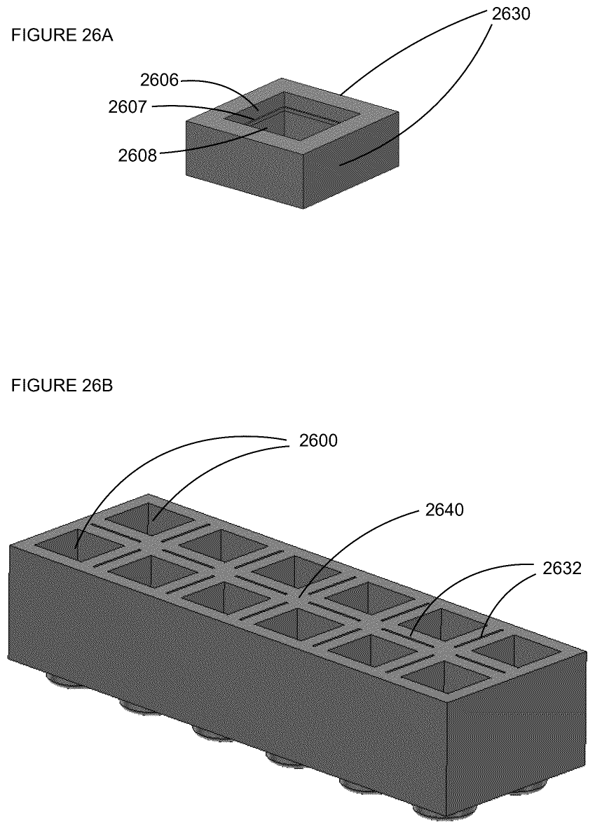

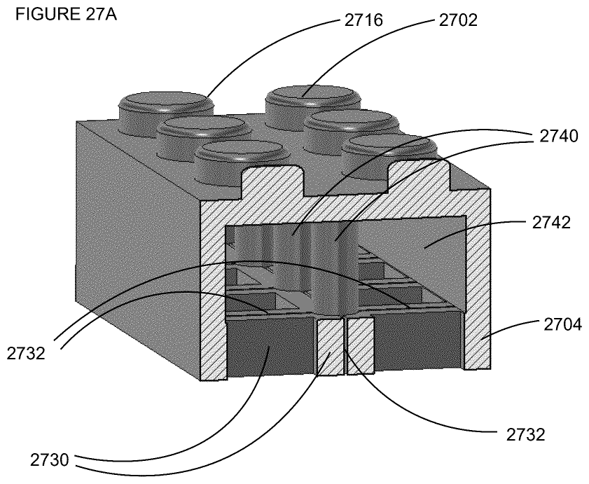

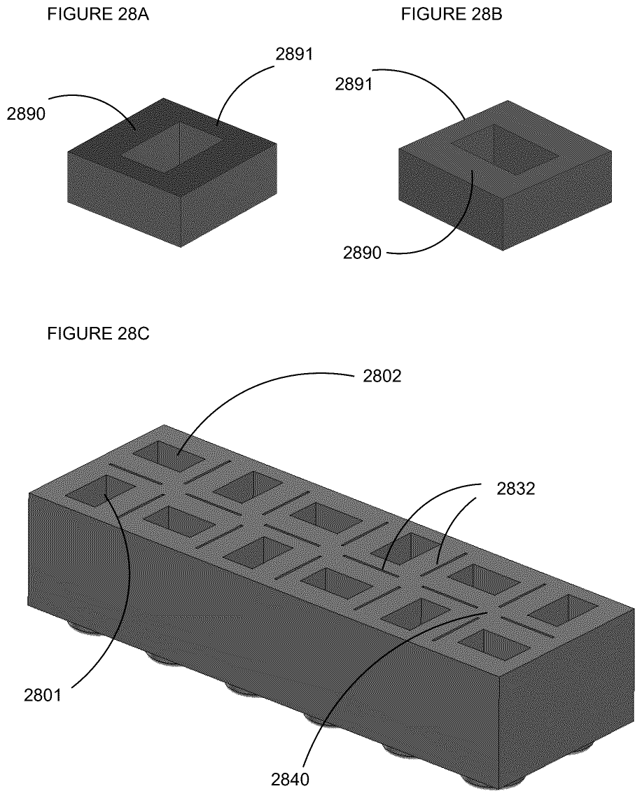

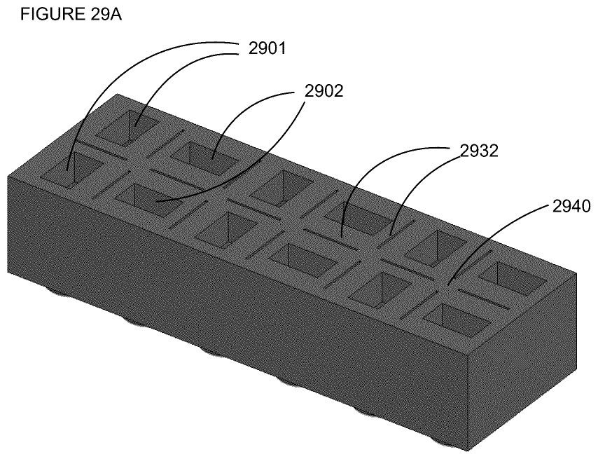

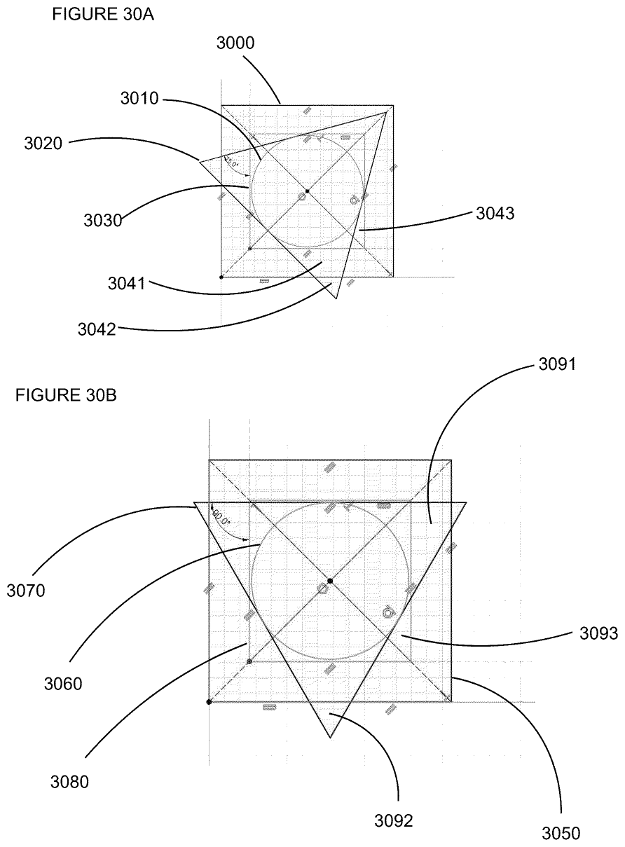

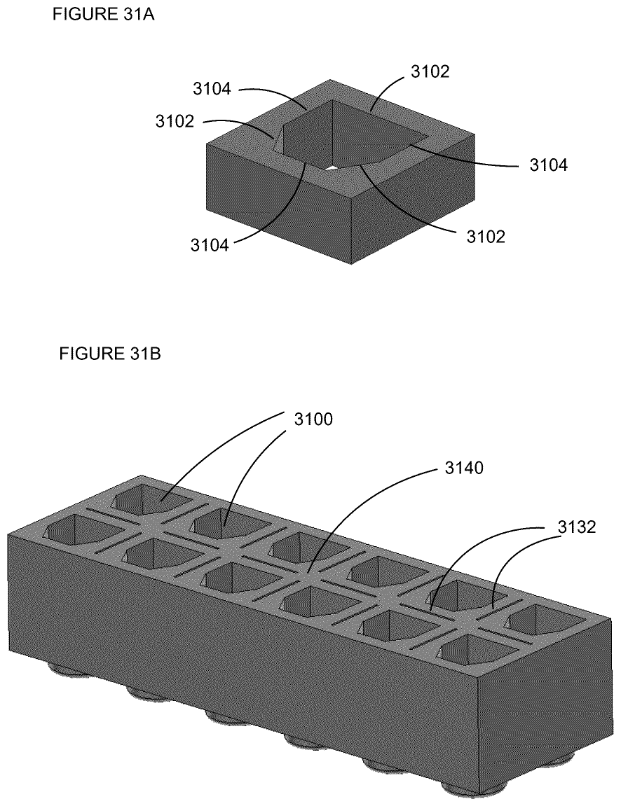

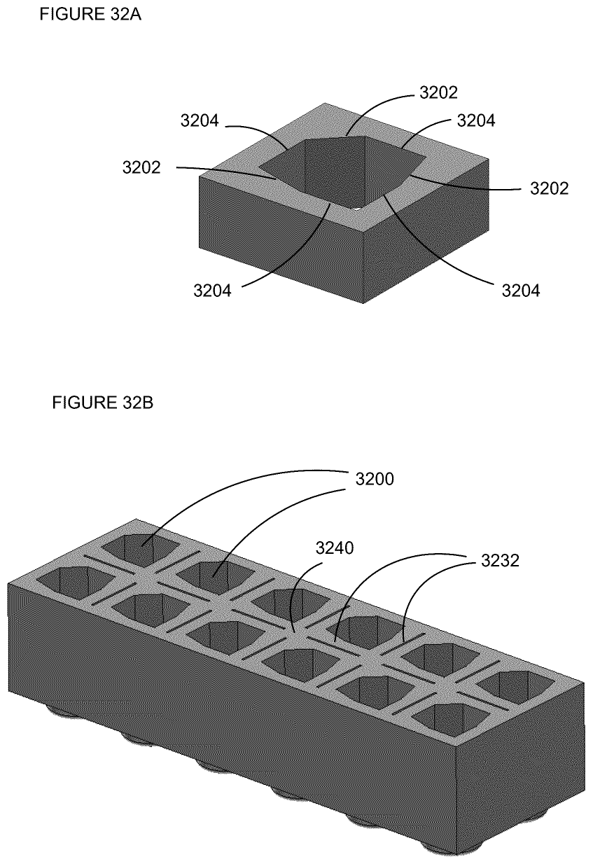

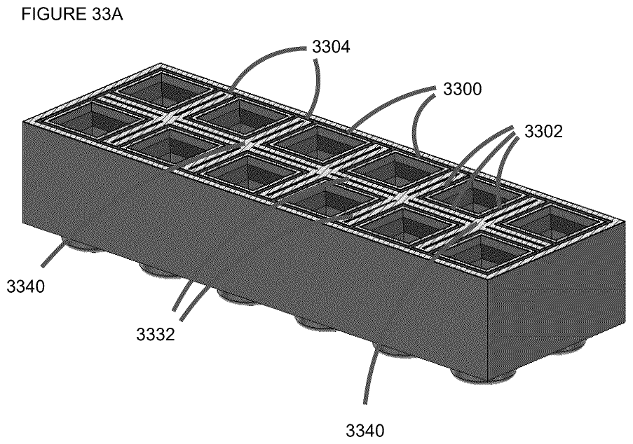

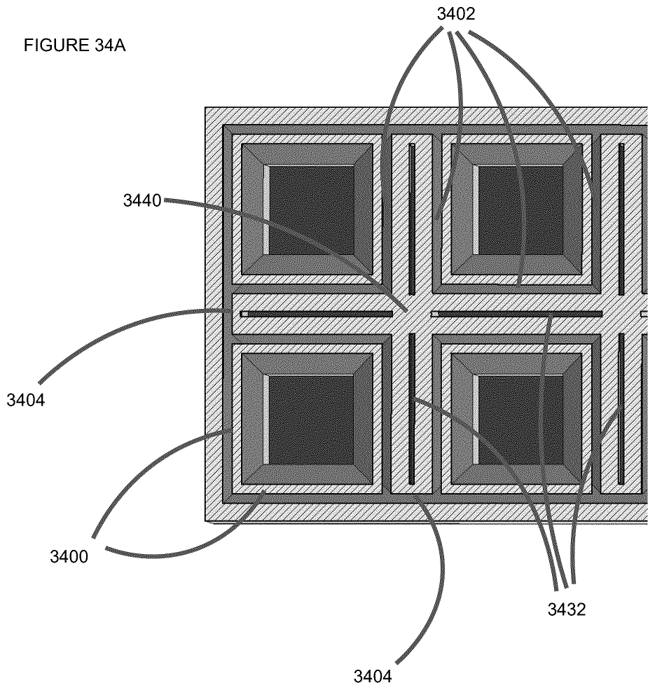

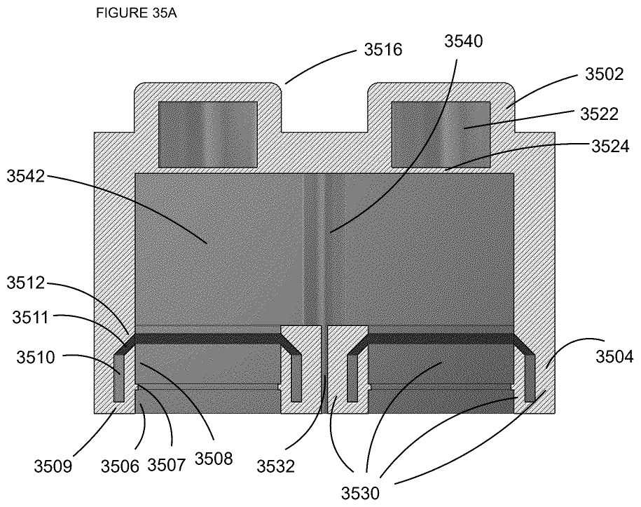

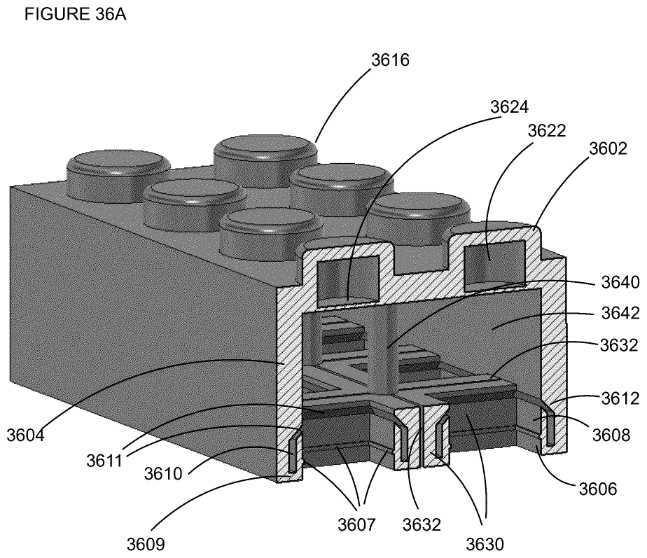

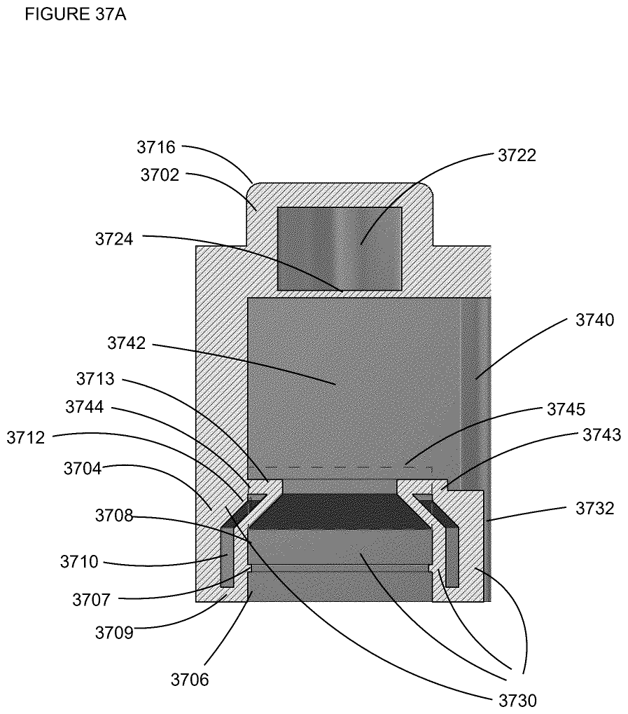

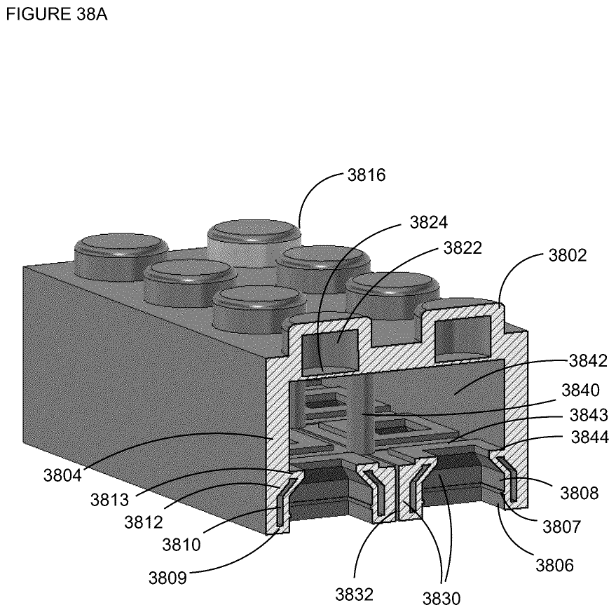

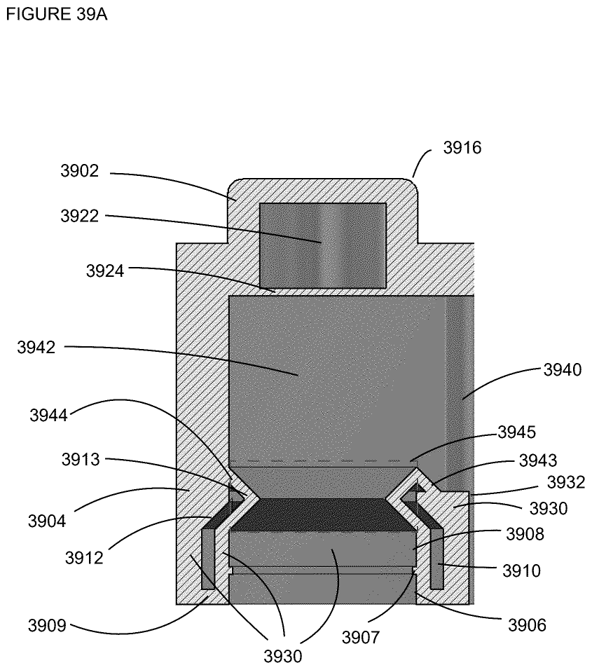

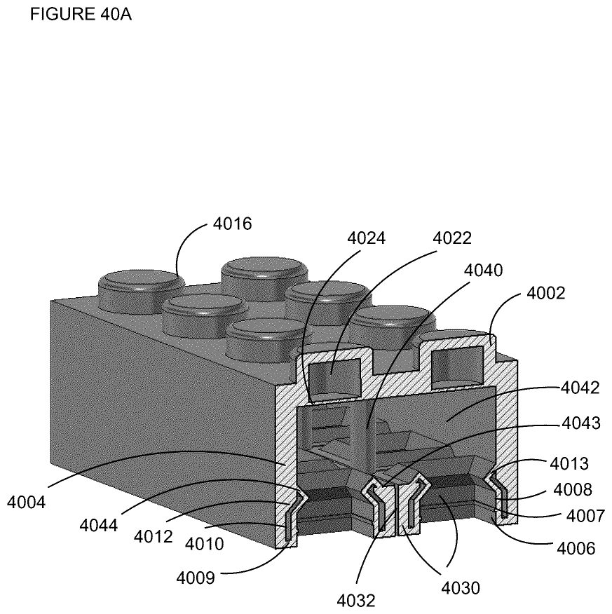

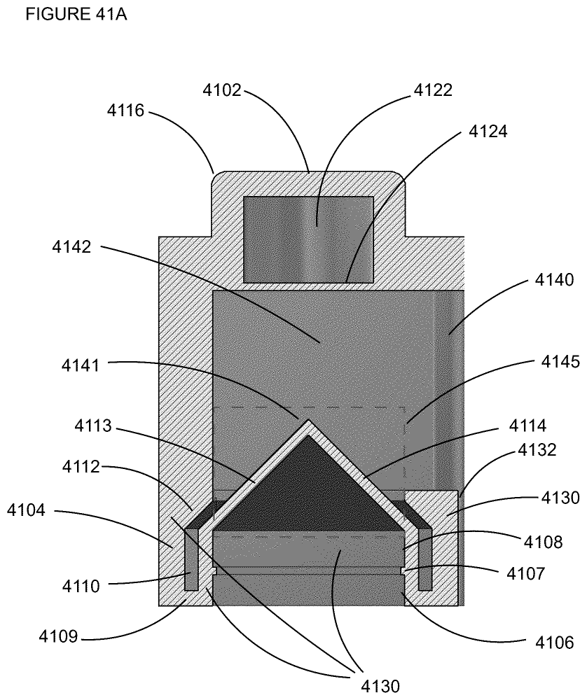

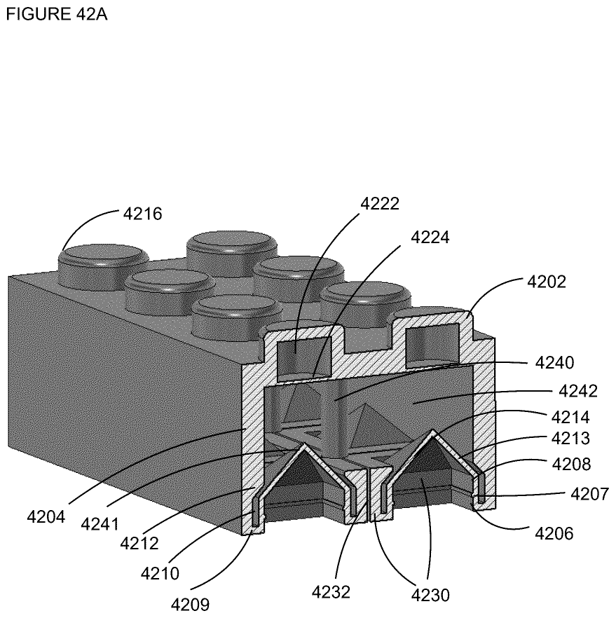

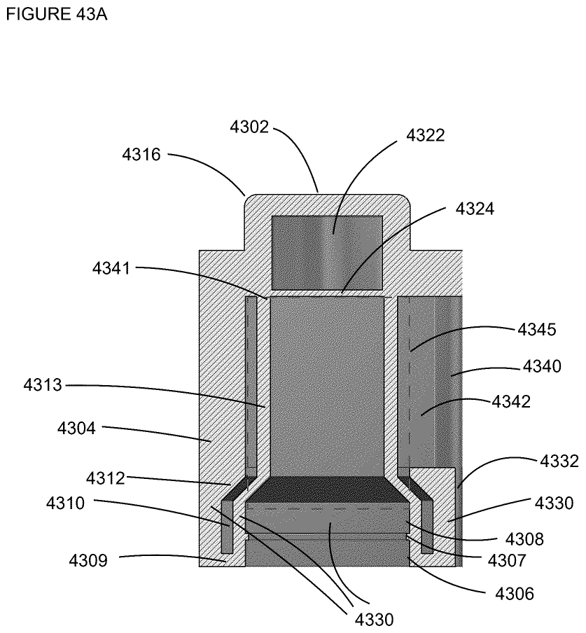

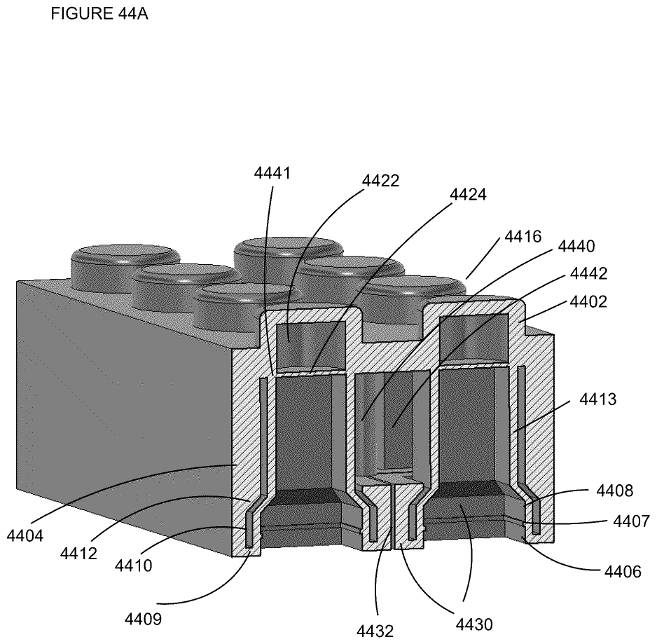

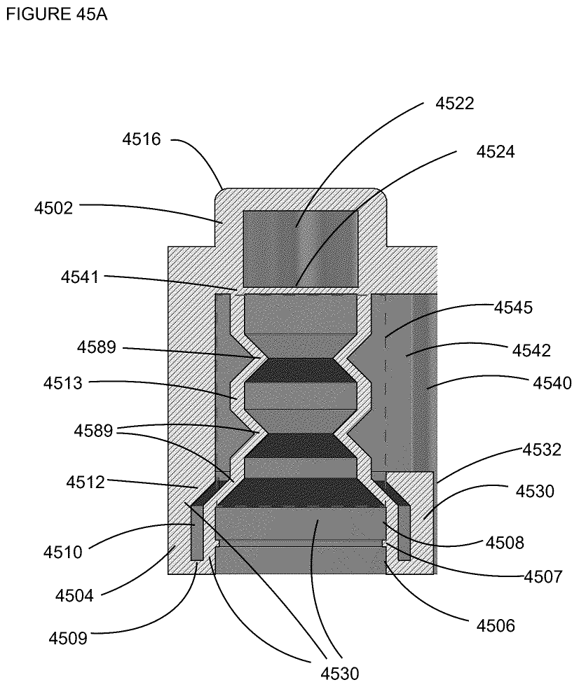

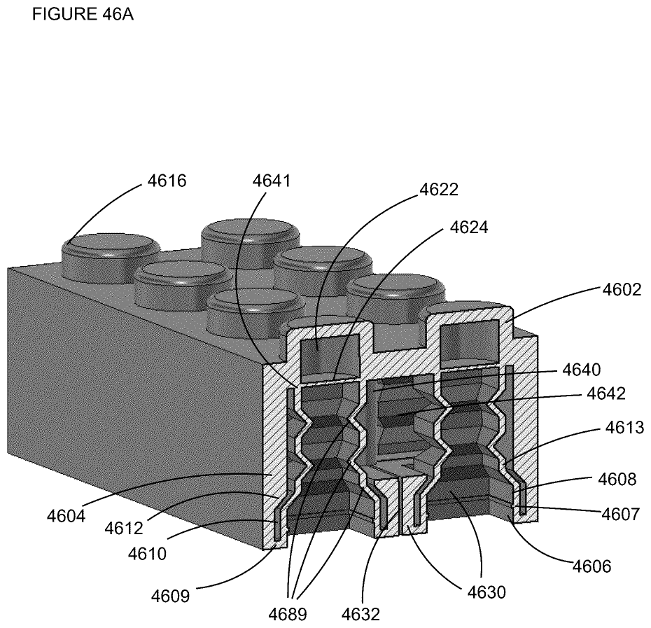

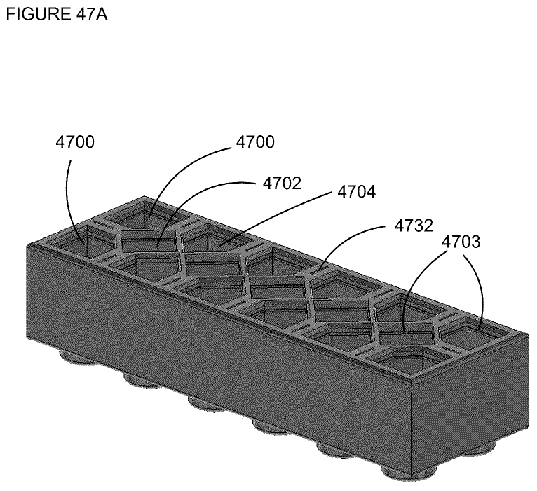

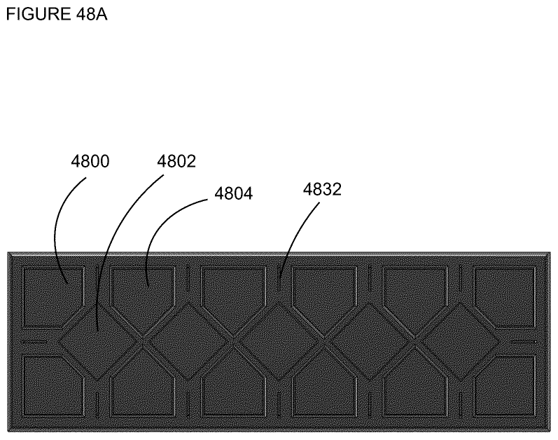

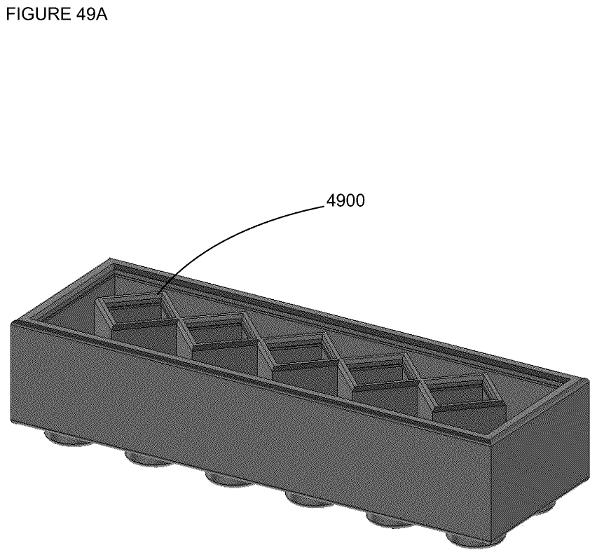

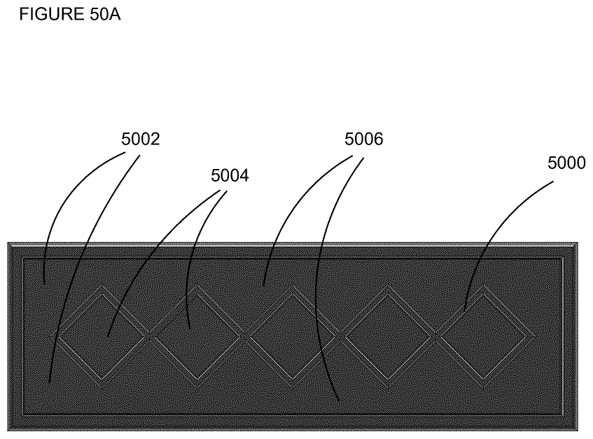

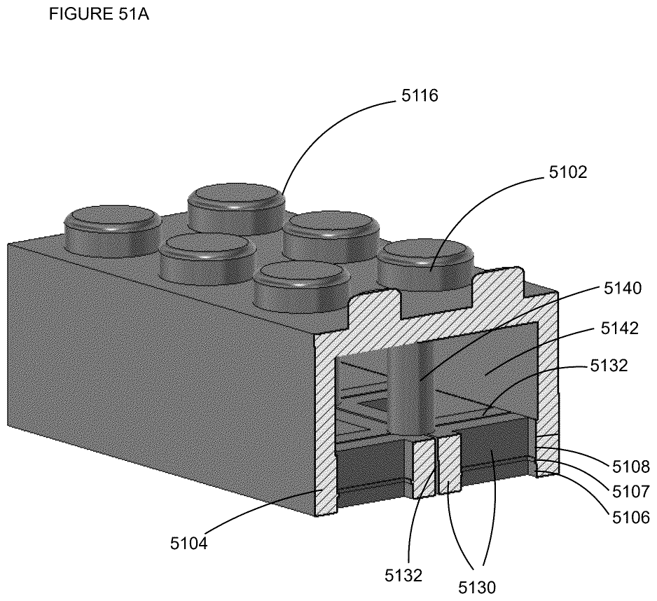

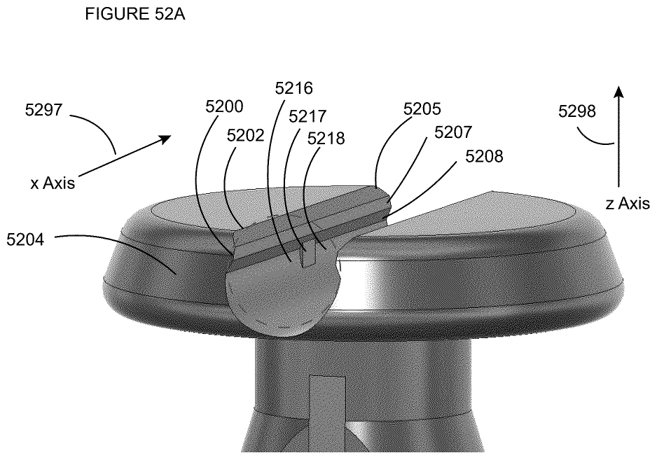

As illustrated in FIG. 7A, a uniform friction fit mechanism has a narrow strike zone and thus requires a relatively tight manufacturing tolerance to achieve a user-satisfactory fit; a compound friction fit mechanism with a nub has a relatively larger strike zone allowing higher manufacturing tolerance; a compound friction fit mechanism with a semi-sacrificial nub has a relatively larger strike zone still allowing even more manufacturing tolerance.

The strike zone and tolerance properties of a fully-sacrificial nub are not straightforward and will depend on the design, post-processing, and intended use parameters. For example, a fully sacrificial nub intended to serve as an indicator of use and to be operated by human force will typically require very precise manufacturing. To the contrary, a fully sacrificial nub intended to be subjected to accelerated wear in (as defined below) will tolerate a large manufacturing variance.

The exact size of a semi-sacrificial nub will vary depending on the size of the objects, the force intended, the machinery, the post processing steps, and the material they are made out of. For 3D printed PLA and PETG nubs, in some embodiments 0.05 to 0.35 mm height nubs are semi sacrificial when 0.05 to 0.35 mm in protrusion. In some embodiments 0.1 mm to 0.2 mm layers with 0.04 mm to 0.16 mm protrusions are useful sizes both for their end properties, ease of manufacture, and ease of wear-in with human force.

In a retail/home manufacturing environment, semi-sacrificial nubs will be customarily worn in by interfacing with a counterpart object made of the same material (e.g. PLA with PLA, PETG with PETG, ABS with ABS, ASA with ASA, etc). As used herein, using a specifically sized counterpart and/or machine pressure is called “accelerated wear-in.” Accelerated wear-in with a wearing tool made of a different material is useful in some embodiments. Particularly, in a commercial or industrial manufacturing environment (but also in some cases in retail or home environment), wearing in with a harder precision milled counterpart will help achieve very rapid and/or precise wear in. As used herein, a counterpart specifically used in wearing, whether hardened, same hardness, or softer, is a “wearing tool.”

An approach that is useful in some embodiments is to use a precision machined metal counterpart wearing tool. The wearing tool can be exact sized, slightly oversized, or slightly undersized depending on the desired end properties. The wearing tool may contain a slope and/or ridges to allow progressive deformation along the stroke length of wear in. The wearing tool may have a thin profile with a hollow interior so that it can act as a sort of knife. Another approach to accelerated wear-in is to use machine pressure, as in a vice.

Wearing tools and machine pressure can be combined.

Accelerated wear-in is useful in post processing a compliant mechanism, including both compound compliant mechanisms and uniform friction fit mechanisms, to upgrade the precision of the mechanism beyond the level achieved with the primary manufacturing machinery. Nubs are particularly useful if the nub, materials, and machinery are matched such that the expected sizes due to manufacturing variances are within the user-satisfactory range after wear in (if any) 95% of the time or more.

A nub will customarily run perpendicular to the interface of an object. A nub may run at other angles. A nub can be oriented at any angle to the interface. When there are multiple nubs, they can be oriented at different angles. When two nubs intersect, intersection shapes can be made of any boolean shape logic, any wave combination/interference logic, or any other logic including bespoke and cut-and-try. In many applications, one or two nubs will be sufficient, but any number of nubs can be overlaid at any number of angles.

Nubs running at an angle can be particularly useful in snugging/nudging the joined objects in one direction or another during assembly or disassembly. Chevron angles are particularly useful in nudging joined objects to one configuration during assembly and/or disassembly. Using nubs at angles as alignment aids is an example of when a fully sacrificial nub may be useful.

Another embodiment of the compound mechanisms is what is referred to herein as a “class 2 compound mechanism” which includes a compliant spring. The direct interface portion of a class 2 compound mechanism may be any type of friction fit mechanism including uniform friction fit mechanisms, class 1 compound mechanisms, or other. A class 2 compound mechanism increases the strike zone, the size range across which a user-satisfactory binding, holding, and separating force can be achieved. In light of the foregoing discussion, it will be apparent that the increased size range achieved with a class 2 compound mechanism confers variance, tolerance, material, manufacturing and other advantages similar to those of a class 1 compound mechanism.

A specific feature of some class 2 mechanisms is what is referred to herein as a “PeriTube” or “Perimeter Tube”—A peritube is a void space behind the interface wall. In function, it is effectively an upper and a lower spring fused together by a third spring that forms the direct interface. It functions as a compliant spring mechanism. In some embodiments a peritube will have space cut out above and below to create more spring sections and/or create thinner springs arms and/or create a longer lever arm for the spring, in others it will remain behind a wall having no apparent spring components.

It will be apparent that the compound spring can be placed in a variety of ways. Compound compliant mechanisms of all classes can be created with myriad manufacturing technologies/machinery types, both additive and subtractive. The manufacturing technologies included but are not limited to: injection molding, FDM 3D printing, cnc machining (including cnc router, cnc lathe and other), resin 3D printing, powder bed 3D printing, and others.

### II. Improvements to Interlocking Construction Bricks

The present invention further improves construction bricks to allow for user-satisfactory performance when manufactured via FDM 3D printing.

The improvements to interlocking construction bricks disclosed herein allows such bricks to be manufactured with a retail-grade FDM 3D printer using common consumer filaments (PLA, PETG, ASA, TPU, etc.) with a high level of user satisfaction. Some blocks in some embodiments of the present design will require wear-in of semi-sacrificial nub/nubs to achieve user-satisfactory action; other embodiments with other materials do not. Many embodiments of the present invention use class 1 and/or class 2 compound mechanisms to improve brick designs and their ability to interlock.

The present disclosure provides a new way of creating the bottom interface of bricks called herein a “cup array.” As used herein, a cup array is an array of 3D objects such that the studs interface into an enclosed cell or “cup” in all binding sites of a 1×2 or larger brick. The cups are often identical, for design simplicity and material variability management. Each individual component can be called a “cup array cell” or simple “cup” or “cell” Cup arrays are useful in creating 3D printed bricks for a few reasons: they aid in managing variability; they allow placing seams away from the area of interface; the uniform nature of the cells makes tuning a design faster and more straight forward; they allow interface areas to be made of long continuous extrusions (often straight or gently curved), which FDM 3D printers can create more precisely than sharp curves or when stopping and starting; all interface points for given binding cell are within a single hole (as detected by slicer software) making tuning for material and machine variance at slicer time both possible and easy; cups overcome the significant problem of variable shrinkage: cups can ensure that all binding points experience similar contraction forces from cooling.

Cup arrays of non homogenous cup shapes are also possible and will retain many of the advantages and inventive features of identical cups. The present disclosure provides cup arrays that are made with the class 1 compound walls, class 2 compound mechanism/compliant springs walls, and uniform walls. Cups that are in the form of extruded polygons, extruded circles, and extruded ovals are useful. It will be apparent with discussion that myriad cup designs with novel properties are possible. A few will be discussed presently.

Square cup array cells are useful for their ease of design, limited additional binding sites (4 vs 3), near identical cooling forces at all sites, and pleasant visual appearance. An “iso-angular cup array cell” or more simply “iso-angular cup” is a useful shape that can be created with bind-sites that are 120 degrees apart. The dimensions of studs of standard bricks relative to their walls do not allow a true triangle, and a hexagon will create six bind sites instead of three. Any modification of a triangle to cut off spikes so that it can fit into the wall space, or hexagon where every other side is moved out so that 3 of the walls do not interface with the stud is an iso-angular cup. Modified hexagon iso-angular cups are useful in managing variability due to differences in shrinkage forces. The existence of other triangular cup/three point cup designs will be apparent.

Rectangular cup array cells are useful in some instances. Rectangular cups can be configured to 1) bind in two locations 180 degrees apart and not bind in the other two or 2) to bind more strongly in two locations 180 degrees apart and bind less strongly in the other two. (an approach to use multiple rectangular cups together and bind in only one location per cup will be discussed below). If the two “weaker” binding locations are in the range of “barely not binding” to “barely binding” it allows the cup to firmly grip with full constraint in either the x or y dimension and limited to no play in the other dimension. Limiting to two bind sites is useful in expanding the strike zone per binding point/tolerable range for overlap where a design is user satisfactory and thus reducing the precision necessary to create the object and reducing the tuning needed between different materials or colors.

Using a different sized nub or differently designed interface on the short end of the cup than the long end of the cup can be additionally useful in controlling play and binding forces. A rectangular cup is useful because it divides the strike zone by only two points, thus giving each binding point more strike zone vs a square which divides the strike zone across 4 points (the same overall effect holds if all 4 points of the rectangle bind, the majority of the strike zone is given to two primary points). A larger strike zone at each point makes achieving user-satisfactory force possible with lower precision machinery. Even though the long and short edges of a rectangular cup do not experience near identical cooling forces, like with a square cup, the forces they experience are very similar. Even with slightly different cooling distortions on short vs long edges of the cup, bricks made with rectangular cups will still be quite easy to tune as all cups in the array experience similar cooling forces/distortions.

In one novel configuration, rectangular cups can be rotated between occurrences, e.g. 90 degrees, in a checkerboard pattern or in an a-b row pattern. A checkerboard configuration of rectangular cups allows full x-y constraint when any two adjacent studs from the counterpart are inserted into any two adjacent binding cells of the brick—the white cells of the checkerboard constrain either the x or the y dimension and the black cells of the checkerboard constrain the other. Alternatively, an a-b row alternation pattern, where the orientation is consistent for all cells in a row, is easier to implement in design software, but only fully constrains the brick with 2 binds in adjacent rows (two binds in the same row will only constrain the brick in x or y). Which of the x-y dimensions is called a row and which is called a column is an arbitrary implementation detail.

It will be apparent that many rotational configurations exist, 90 degrees has the advantage that it is the simplest to design. 45 degree rotations create 4 unique cell shapes, 15 degree rotations create 12 unique cell shapes, 5 degree rotations create 36 unique cell shapes, 1 degree rotations create 180 unique cell shapes, and so on. The rotation between cells can even be a random pattern, provided that no two adjacent cells have the same bearing. Testing indicates that a 15 degree or greater difference is sufficient to allow no perceptible play when two studs bind into two adjacent cells.

Extending the usefulness of rectangular cup cells further, if placed specifically offset from center and sized such that only one edge overlaps a counterpart stud, an array of 4 rectangular cups can be arranged in an ABCD checkerboard configuration such that each cup constrains a counterpart stud in only one dimension of the 4: x positive, x negative, y positive, y negative. To achieve this, the binding vectors of cups A, B, C, and D must be approximately 90 degrees offset. In such an arrangement, any 4 adjacent studs can create a fully constrained bind when interfaced with any 4 adjacent cups.

Blending the concepts of an ABCD checkerboard with a triangular or iso-angular cup: if the bind sites of an iso-angular cup are distributed among four cells, then the X-Y movement of a counterpart brick can be fully constrained with only 3 binds. To achieve this, the binding vectors of cups A, B, and C must be in a triangular pattern and cup D must have no binding. Each cups must also only overlap the counterpart stud on one edge. As seen elsewhere, the reduction in the number of binds expands the strike zone per binding site, thus reducing the precision necessary to create the object and reducing the tuning needed between different materials or colors.

By cutting out a cup in each four corner intersection of a rectangular/square cup array, a “modified cup array” can be created that is compatible in exactly all binding configurations as are achievable in a standard brick with under-cylinders. A diamond or modified hexagon shape is well suited for the overlaid cup, but myriad options exist.

A simplified embodiment of the modified cup array goes nearly full circle to the standard design-the diamond or hexagon shape can be used alone, in place of a round under cylinder, and without the other cups. This can achieve a tri-bind like a standard brick with an under cylinder and with the same angles away (two binds 90 degrees apart and a third bind 135 degrees from the first two) with the advantage that the binding area is made from a straight section and FDM 3D printed seams can easily be moved to non-interface corners, and shrinkage changes to binding cell size/force of a “diamond cylinder” will be more manageable than if a regular cylinder is used. In such embodiment, the diamond or hexagon “under cylinder” must reach the full height of the brick.

A cell in a cup array can rise the entire distance to the top of the brick (creating a very sturdy object that resists flex/torsion), or for a limited distance (limiting the amount of material needed and allowing the brick to be twisted/flexed slightly). Each configuration has advantages. Leaving a gap between cups is useful in creating uniform wall widths on every side. As used herein, such gaps are called force normalization joints. These are useful because: It reduces variability of shrinking forces; It reduces variability in wall width, which reduces variability in bind strength caused by thicker walls pushing back more strongly against deformation than thinner walls.

Fusing the cups at the corners is useful for improving bed adhesion. The corner joining object can be extruded to the height of the cup only, or all the way to the top of the brick.

Extending the corner joining object to the top of the brick is useful in managing torsion/flexibility as well as reducing the amount and length of the bridging lines necessary to print the ceiling. As used herein, these are called joining rods.

### III. Specific Embodiments of Bricks

Various specific dimensions and configurations are disclosed herein.

A set of specific embodiments that are useful for a brick measuring 2 studs deep by 2+studs wide is:
A class 1 compound compliant mechanism is placed on the inner perimeter of the wall starting 0.4 to 1.2 mm above the base. The nub of said mechanism is 0.05 to 0.4 mm in height and 0.05 to 0.30 mm in width.
A sloped positioning aid is placed at the bottom of the wall rising 0.05 to 0.6 mm and running at a 25 to 75 degree angle
A sloped positioning aid is placed at the bottom of the wall rising 0.05 to 0.6 mm and running along a circular or elliptical.
A class 1 compound compliant mechanism is placed on the circumference of each stud, the nub of said mechanism is placed 0.4 to 1.2 mm above the base of the stud. The nub of said mechanism is 0.05 to 0.4 mm in height and 0.02 to 0.18 mm in width.
A rounded positioning aid is placed at the top of the stud rising 0.05 to 0.6 mm and running at a 25 to 75 degree angle
A rounded positioning aid is placed at the top of the stud rising 0.05 to 0.6 mm and running along a circular or elliptical path.
A class 1 compound compliant mechanism is placed on the circumference of each under cylinder starting 0.4 to 1.2 mm above the base. The nub of said mechanism is 0.05 to 0.4 mm in height and 0.05 to 0.25 mm in width.
A sloped positioning aid is placed at the bottom of the under cylinder rising 0.05 to 0.6 mm and running at a 25 to 75 degree angle
A sloped positioning aid is placed at the bottom of the under cylinder rising 0.05 to 0.6 mm and running along a circular or elliptical.
Stabilizer wings of 0.3 to 1.6 mm in width are placed between the under cylinders and the side walls.
Stabilizer wings are placed 2.0 to 5.0 mm above the bottom of the brick.
Stabilizer wings have a sloped under profile rising at 25 to 75 degrees from the sidewall, the under cylinder
Stabilizer wings have a chevron profile and rise from 25 to 75 degrees from both the under cylinder and the sidewall.
Any combination of the above where the wall and cylinder nubs are at the same height.
Any combination of the above where the stud nub is placed lower than the wall and cylinder nubs such that they do not interface with one another. E.g. stud nub of 0.2 mm height at z=0.4 and wall and cylinder nubs are 0.2 mm height at z=0.8.
Any combination of the above where the cylinder and wall nubs are of different width.
Any combination of the above where the nubs are 0.09 to 0.22 mm in height.

A set of specific embodiments that are useful for a brick measuring 1 stud deep by 1+studs wide:
A class 1 compound compliant mechanism is placed on the inner perimeter of the wall starting 0.4 to 1.2 mm above the base. The nub of said mechanism is 0.05 to 0.4 mm in height and 0.02 to 0.22 mm in width.
A sloped positioning aid is placed at the bottom of the wall rising 0.05 to 0.6 mm and running at a 25 to 75 degree angle
A sloped positioning aid is placed at the bottom of the wall rising 0.05 to 0.6 mm and running along a circular or elliptical.
A class 1 compound compliant mechanism is placed on the circumference of each stud, the nub of said mechanism is placed 0.4 to 1.2 mm above the base of the stud. The nub of said mechanism is 0.1 to 0.4 mm in height and 0.02 to 0.18 mm in width.
A rounded positioning aid is placed at the top of the stud rising 0.05 to 0.6 mm and running at a 25 to 75 degree angle
A rounded positioning aid is placed at the top of the stud rising 0.05 to 0.6 mm and running along a circular or elliptical path.
Any combination of the above where the stud nub is placed lower than the wall nub such that they do not interface with one another. E.g. stud nub of 0.2 mm height at z=0.4 and wall nubs are 0.2 mm height at z=0.8.
Any combination of the above where the nubs are 0.09 to 0.22 mm in height.

### IV. Embedded Designs and Manufacturing Methods

The invention includes methods for embedding designs and specific manufacturing parameters.

The present disclosure includes an improvement to interlocking construction bricks allowing the embedding of text and other designs into the sidewalls. As used herein, a “design object” is a text, image, vector, or other design. It will be understood that “text design object” means a design object that is text. To achieve a monogrammed effect, during the design stage a second (or further) object is cut out of the sidewall and during the slicing and the manufacturing stages a second (or further) color material is used both decoratively to create the text/design and structurally to fill in the empty space in the sidewall.

As used herein, embossed has the colloquial meaning of “raised from or offset into.” In most uses referring to the “offsetting into” meaning, which is sometimes more specifically referred to as debossing. Similarly “offset” is used meaning “a distance from” in either direction, and “offset into” will be used when some might say “inset.” These terms are used as such because it is how they are used in the design software used to create the present disclosures.

Specifically:
The design object is offset 0.05 mm to 0.5 mm into the sidewall and the space between the offset and outer face of the sidewall is removed/left void to form an indentation. This offset allows oozing, seams, and corner defects to be hidden away from the face of the object and gives a pleasing chiseled effect to the end object.
The design object is sized such that it is: the full depth of the remaining wall (it spans from the outer offset depth to the inner edge of sidewall)—or—the design object is 0.2 to 1.3 mm in depth with at least 0.1 mm of wall behind. This can be useful in reducing the total number of wall objects that need to be printed and thus reducing 3D printing artifacts due start-stops and wall wiping (when the 3D printer wipes excess plastic from the nozzle onto the wall prior to moving to another section, so as to prevent plastic from stringing as the nozzle travels).
The outer side wall approaching the design object is chamfered/beveled at 15 to 75 degrees on all sides-or- a single draft/chamfer/bevel on the upper edge. Drafting the upper edge allows for printing outer-wall first without the line above the letter “sagging”

The design object can be embedded into the sidewall of the brick using pixels:
The design is converted into a 1+color pixel map representation (e.g. bitmap) with pixels between 0.05 by 0.05 mm and 1 mm by 1 mm pixels. (assuming white or background is not counted as a color). Pixel maps of 1, 2, 4, 8, 12, and 16 colors are useful.
If the design is to be 3D printed: Pixels that are an even increment of the intended layer size are useful (e.g. 0.1 mm layers benefit from 0.1×0.1 mm, 0.2×0.2 mm, 0.3×0.3 mm, etc.) Pixels that are within −50% and +50% of the intended extrusion line width are useful (e. g if using a 0.42 mm line width, 0.3, 0.4, 0.5, and 0.6 mm pixels are good sizes). Adjusting the line width to match the pixel size exactly is useful. Using a variable width wall engine, e.g. arachne, for slicing is useful.
Pixels between 0.08×0.08 mm and 0.50×0.50 mm are useful in some embodiments
In some embodiments using a pixel size that is cleanly divisible into the stud pitch is useful
The map is split into individual maps for each color.
The maps are imported into 3D modeling/design software.
Each single-color map is used to create a body/bodies that is embedded into the sidewall of the brick per the procedures and specifications for text provided above.
Optionally, spacers can be set up at periodic increments in the pixel grid to maintain an embossed and chiseled effect or avoided to generate a more uniform appearance.
Optionally, the exact size of the brick in x, y and z can be adjusted to be an even increment of the pixels aiding in creation of multi-brick designs. There is customarily 200 microns of xy gap/clearance between standard bricks.
Care should be taken to account for variations in first layer height, z gap between assembled blocks, and x-y gap between bricks. Careful accounting for gaps ensures that designs are not perceptibly stretched even if the design spans many bricks both wide and tall.
Differences in pitch between studs and pixels can be hidden in the x-y gap between blocks.

The design object can be embedded into the sidewall of the brick using vectors:
The design is converted into a 1+color vector representation (assuming white or background is not counted as a color).
Using x-y to describe 2 dimensional features of an image: By hand or using software, vectors are adjusted to cleanly fit onto a y-axis grid equal to the layer height the brick will ultimately be printed with. By hand or using software, vectors are adjusted to ensure a minimum x width of each feature where the x width is the layer height or greater.
The design is split into one vector per color.
The vectors are imported into 3D modeling/design software.
Each single-color vector is used to create a body/bodies that is embedded into the sidewall of the brick per the procedures and specifications for text and pixels provided above.
Care should be taken to account for variations in first layer height, z gap between assembled blocks, and x-y gap between bricks. Careful accounting for gaps ensures that designs are not perceptibly stretched even if the design spans many bricks both wide and tall.

In some embodiments, It is useful if a custom font is created with most or all features having a minimum width of 0.2 mm when printed at 4 mm height. A useful embodiment is if the design is a QR code. Another useful embodiment is if the design is a Logo.

In manufacturing compound mechanisms, bricks, and/or bricks with embedded designs, it has been observed that using one or more of the following manufacturing approaches improve outcomes. It should be apparent that some elements are inventive on their own and that myriad combinations/permutations are both inventive and useful:

Using an FDM 3D printer to print compound compliant mechanisms; Using an FDM 3D printer to print interlocking construction bricks; Using an FDM 3D printer to print interlocking construction bricks containing compound compliant mechanisms; Using an FDM 3D printer to print interlocking construction bricks containing any of the inventive elements disclosed in “Invention 1” or “Invention 2” in this document, or any combination; Using an FDM 3D printer to print interlocking construction bricks that have text or graphics embedded as a relief; Using an FDM 3D printer to print interlocking construction bricks that have text or graphics embedded as an object of a second color; Using an FDM 3D printer to print interlocking construction bricks that have text or graphics embedded as a relief and any of the inventive elements disclosed in “Invention 1” or “Invention 2” in this document, or any combination; Using an FDM 3D printer to print interlocking construction bricks that have text or graphics embedded as an object of a second color and any of the inventive elements disclosed in “Invention 1” or “Invention 2” in this document, or any combination; Using an FDM 3D printer to print interlocking construction bricks that have a design of 2 or more colors embedded as an array of pixels; Using an FDM 3D printer to print interlocking construction bricks that have a design of 2 or more colors embedded as an array of pixels and any of the inventive elements disclosed in “Invention 1” or “Invention 2” in this document, or any combination.

Using an automatic material system or automatic toolhead changer to allow multiple colors or multiple materials; Using colored PLA; Using colored PETG; Using colored ASA;

Using colored ABS; Using colored TPU; Printing a text or design object embedded in the sidewall with a different color than the rest of the brick; The same wherein more than 2 colors are used; The same wherein up to 16 total colors are used; Using a nozzle between 0.2 and 0.8 mm in size; Using a 0.4 mm nozzle; Using layer line heights of 0.05 to 0.35 mm; Using layer line heights of 0.08-0.11 mm; Using layer line heights of 0.18 to 0.22 mm.

Printing portions of the compound compliant mechanism in one material (e.g. TPU, PETG, ABS, ASA) while printing the rest in another material (e. g PLA). The same where the majority of the brick is made from a bioplastic such as PLA; Printing the interface portions in a different material than the rest of the brick (e.g. nubs in ASA and bricks in PLA, nubs in ABS and bricks in PETG, etc.); Printing the interface portion with a petroleum based plastic while printing the non interface portions in a bioplastic.

Increasing the size of the bricks 0.1-2.5% in the x and y dimension prior to printing; Slicing and printing using a variable width wall engine; Slicing and printing using variable line heights; Printing the outer wall first; Outer wall speed set to between −50% and +100% of first layer speed; Outer wall acceleration set to between −50% and +100% of first layer acceleration.

Rotating the objects −10 to −0.01 or +0.01 to +10 degrees to force the slicer to align the seams; Rotating the objects 12.5 to 77.5 degrees to manage the placement of seams and thus optimally place the larger portion of studs in a useful location. Rotating the objects to between 17.5 and 27.5 degrees to have seams non interfering with bind site of both square cup arrays (which bind at four 90 degree angles) and standard wall and cylinder bricks (which bind to the studs at a variety of angles, some in 90 degree increments, others at 45 degree increments). Or the same rotations plus 90, 180, 270 degrees. Rotating the objects 22.5 to 67.5 degrees to manage seam placement. Or the same rotations plus 90, 180, 270.

Using glue on the build-plate. This is helpful in reducing warping at the edges. Using a multi-layer build plate. This is helpful in reducing warping at the edges. Using a 0.4 to 5 mm brim with 0.1 to 0.25 mm gap. This is helpful in reducing warping at the edges. Using a skirt of 1-5 passes and 0.2 to 5 mm in height. This is helpful in reducing warping at the edges, especially when using unenclosed printers. Using mouse ear brims. This is helpful in reducing warping at the edges. Using an enclosure. This is helpful in reducing warping at the edges. Using an actively heated enclosure. This is helpful in reducing warping at the edges.

Using an initial layer height of 50-99% of the other layers to lower the object to achieve better z axis compatibility with Standard Blocks. Adjusting x-y hole compensation to −0.35 to +0.35 to adjust the size of the binding cells tighter to looser respectively. This is useful in adjusting to machine and/or material variance. Adjusting x-y contour compensation to −0.350 to +0.350 mm to adjust the size of the studs to make the binding looser or tighter respectively This is useful in adjusting to machine and/or material variance. Using x-y hole and/or x-y contour compensation to adjust the size of the printed object without having to change the size of the 3D object.

Using a set of pre-made tuning blocks with a range of x-y hole and/or contour variances to rapidly identify settings needed to achieve user-satisfactory binds, e.g. with a new printer or with a new filament. In further embodiments, the tuning blocks have text embedded to more easily identify which tuning is being tested. In Further embodiments, the tuning blocks for binding sites (the under side of the brick) are made without studs. Removing studs helps an end-user keep straight which dimension they are modifying and otherwise limits confusions from tuning bricks, some of which are inevitably wrong sized, being mixed in with ostensibly right-sized bricks. In Further embodiments, the tuning blocks for studs (the upper side of the brick) are closed at the bottom. Removing binding sites helps an end-user keep straight which dimension they are modifying and otherwise limits confusions from tuning bricks, some of which are inevitably wrong sized, being mixed in with ostensibly right-sized bricks. In further embodiments, multiple tuning blocks are pre configured and made available in 3 mf file.

Using nubs sized in height increments of the layer height used by the 3D printing slicer E.g. 0.08, 0.1, 0.12, and 0.2 mm; Creating nubs with offsets greater than line width by stair-stepping, overhanging sequential layers; Placing the nubs at a height(s) that are an even multiple of the layer height used by the 3D printing slicer (e.g. if the layer height is 0.2 mm, a 0.2 mm tall nub at 0.8-1.0 mm from the bottom of the interface).

Using any or a combination of the discussed mechanisms to compensate for variations in material from batch to batch or color to color; Using any or a combination of the discussed mechanisms to compensate for variations between materials; Using any or a combination of the discussed mechanisms to compensate for machine-to-machine fine tuning; Using any or a combination of the discussed mechanisms to reduce warping at edges of objects; Using any of the previously described mechanisms to achieve accelerated wear in; Using a wearing tool as previously described.

Managing the process using 3D files configured as such: The block is one sub-object of a 3D file (e.g. STEP or 3MF) and the text or design is a second sub-object. This aids in rapidly configuring a slicer to print the design. The block is one sub-object of a 3D file and one sub-object per color is created of a color map of up to 16 different colors. This allows rapid configuration in a slicer.

Managing the process of creating 3D files with scripting to the effect of: Calculate the number of studs necessary to accommodate a given text or design; When embedding a design, automatically create the masks needed for each color and orchestrating the design software to place and extrude the pixels; When embedding a design, orchestrate the design between multiple bricks and allow for arbitrarily sized bricks with arbitrarily sized patterns of resulting bricks.

1. An interlocking construction brick comprising: a top surface comprising a plurality of studs; a plurality of side walls defining an outer perimeter; and a bottom interface defining a cup array; wherein the cup array comprises a plurality of discrete cup cells arranged in a repeating pattern, each cup cell defining an internal cavity configured to receive a counterpart stud; and wherein adjacent cup cells are separated by force normalization joints comprising gaps of non-zero width separating adjacent cup cells.

2. The interlocking construction brick of claim 1, wherein the discrete cup cells comprise a cross-sectional shape selected from the group consisting of: square, rectangular, and iso-angular.

3. The interlocking construction brick of claim 2, wherein the cup cells are rectangular, and wherein the orientation of adjacent rectangular cup cells is rotated by approximately 90 degrees relative to one another in a checkerboard pattern.

4. The interlocking construction brick of claim 1, wherein at least one wall of the internal cavity of a cup cell comprises a compound compliant mechanism, said mechanism comprising: a positioning aid; a run-in section; and at least one nub protruding into the internal cavity; wherein the nub is configured to provide an interference fit with a counterpart stud.

5. The interlocking construction brick of claim 4, wherein the nub is a semi-sacrificial nub configured to undergo shearing or permanent deformation upon a first assembly with the counterpart stud to widen a manufacturing tolerance strike zone.

6. The interlocking construction brick of claim 4, wherein the compound compliant mechanism further comprises a compliant spring lever arm integrated into the wall of the cup cell (Class 2 mechanism).

7. The interlocking construction brick of claim 6, wherein the compliant spring lever arm forms a peritube void behind the interface area.

8. The interlocking construction brick of claim 1, further comprising joining rods connecting the cup array to the top surface of the brick through a void space defined between the cup array and the top surface.

9. A compound compliant mechanism for friction-fit fastening in an additively manufactured article, comprising: an outer portion and an inner portion defining an interface area; wherein at least one of the outer portion or inner portion comprises a surface profile having: a sloped positioning aid; a run-in section adjacent to the positioning aid; and a nub extending from the surface profile; wherein the nub is sized to be semi-sacrificial, such that an excess protrusion of the nub is sheared or deformed during a first assembly operation.

10. The compound compliant mechanism of claim 9, wherein the nub has a height of between 0.05 mm and 0.4 mm.

11. A method of manufacturing an interlocking construction brick using fused deposition modeling (FDM), the method comprising: depositing a thermoplastic material layer-by-layer to form a brick structure; forming a cup array on a bottom side of the brick structure, wherein the cup array comprises discrete cells separated by force normalization joints; and embedding a design object into a sidewall of the brick structure; wherein the design object is offset into the sidewall by a depth of 0.05 mm to 0.5 mm.

12. The method of claim 11, wherein the design object is printed using a second material color distinct from the sidewall.

13. The method of claim 11, further comprising rotating the brick structure on a print bed by 12.5 to 77.5 degrees to manage placement of layer seams.

14. The method of claim 11, further comprising forming a semi-sacrificial nub on an interface of the cup array, and subjecting the nub to an accelerated wear-in process using a wearing tool.

15. The interlocking construction brick of claim 1, wherein each discrete cup cell is coaxially aligned with a respective stud on the top surface of the brick.
